(19) United States
(12) Patent Application Publication
(10) Pub. No.: US 2026/0239209 A1
(43) Pub. Date: Aug. 13, 2026

(54) WAVEFORM GENERATION FOR WAKEUP SIGNALING

(71) Applicant: QUALCOMM Incorporated, San Diego, CA (US)

(72) Inventors: Chao WEI, Beijing (CN); Ahmed ELSHAFIE, San Diego, CA (US); Yuchul KIM, San Diego, CA (US); Wei YANG, San Diego, CA (US)

(21) Appl. No.: 19/155,871

(22) PCT Filed: Apr. 14, 2023
(86) PCT No.: PCT/CN2023/088268

§ 371 Date: Aug. 12, 2025

(51) Int. Cl. H04W 52/02

(52) U.S. Cl. CPC H04W 52/0235

(57) ABSTRACT

Methods, systems, and devices for wireless communications are described. A user equipment (UE) may receive a control signal indicating a waveform type for a wake-up signal (WUS) and one or more parameters. The UE may monitor for the WUS based on the parameter(s) and decode the WUS, where a first bit value for obtaining one or more bits of the WUS is based on a base frequency and a second bit value is based on a frequency shift relative to the base frequency according to a pair of frequency shift values. The UE may also transmit a control signal indicating a transition time for activating a main radio of the UE, may receive a control signal indicating gap values for WUS reception occasions, and may monitor for a WUS based on a first gap value. The UE may activate the main radio based on the indicated transition time.

### CROSS REFERENCE

The present Application is a 371 national phase filing of International PCT Application No. PCT/CN2023/088268 by WEI et al., entitled “WAVEFORM GENERATION FOR WAKEUP SIGNALING,” filed Apr. 14, 2023, which is assigned to the assignee hereof, and which is expressly incorporated by reference in its entirety herein.

### TECHNICAL FIELD

The following relates generally to wireless communications, and more specifically to waveform generation for wake-up signals (WUSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support waveform generation for wake-up signals (WUSs). For example, the described techniques enable a wireless communications system to generate a waveform, such as a frequency-shift keying (FSK) waveform, for a WUS based on a frequency shift modulation of a base signal. In some examples, a user equipment (UE) may receive a control signal (e.g., from a network entity) indicating a waveform type, such as a modulated FSK waveform type, for the WUS. For example, the control signal may indicate a base frequency and one or more pairs of frequency shift values to be applied to an FSK waveform of the WUS. The network entity may modulate the WUS accordingly, and based on the waveform type, the UE may monitor for, receive, and decode the WUS to obtain one or more bits. In some examples, a first bit value (e.g., a zero bit value) may be based on the base frequency and other bit values (e.g., non-zero bit values) may be based on frequency shifts according to the one or more pairs of frequency shift values.

A wireless communications system may additionally support sleep states for a UE according to different transition times. For example, a UE may transmit a control signal indicating a transition time for activation of a main radio of the UE. The transition time may be based on a capability of the UE, such as the capability of the main radio or wake-up radio of the UE, among others. The UE may receive a second control signal indicating one or more gap values for one or more WUS reception occasions for monitoring for one or more WUSs, where the one or more WUS reception occasions may be associated with a paging signal reception occasion for monitoring for a paging signal. In some examples, the UE may monitor, during a sleep state using a wake-up radio of the UE, for a WUS during one of two WUS reception occasions based on a first gap value and the transition time of the UE. Additionally, or alternatively, the UE may transition a main radio to an active state immediately following the WUS reception occasion or after a delay based on an indication within a received WUS.

A method for wireless communications at a UE is described. The method may include receiving a control signal indicating a waveform type for a WUS for the UE and indicating one or more parameters for the waveform type, where the one or more parameters indicate a base frequency for the WUS and a pair of frequency shift values associated with the WUS, monitoring, using a wake-up radio of the UE, for the WUS of the waveform type based on the one or more parameters, and decoding the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

An apparatus for wireless communications at a UE is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the UE to receive a control signal indicating a waveform type for a WUS for the UE and indicating one or more parameters for the waveform type, where the one or more parameters indicate a base frequency for the WUS and a pair of frequency shift values associated with the WUS, monitor, using a wake-up radio of the UE, for the WUS of the waveform type based on the one or more parameters, and decode the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

Another apparatus for wireless communications at a UE is described. The apparatus may include means for receiving a control signal indicating a waveform type for a WUS for the UE and indicating one or more parameters for the waveform type, where the one or more parameters indicate a base frequency for the WUS and a pair of frequency shift values associated with the WUS, means for monitoring, using a wake-up radio of the UE, for the WUS of the waveform type based on the one or more parameters, and means for decoding the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

A non-transitory computer-readable medium storing code for wireless communications at a UE is described. The code may include instructions executable by at least one processor (e.g., directly, indirectly, after pre-processing, without pre-processing) to receive a control signal indicating a waveform type for a WUS for the UE and indicating one or more parameters for the waveform type, where the one or more parameters indicate a base frequency for the WUS and a pair of frequency shift values associated with the WUS, monitor, using a wake-up radio of the UE, for the WUS of the waveform type based on the one or more parameters, and decode the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

In some examples of the method, apparatuses, and non-transitory computer-readable medium described herein, decoding the WUS may include operations, features, means, or instructions for obtaining one or more bits associated with the second bit value based on a first frequency shift relative to the base frequency in accordance with a first frequency shift value of the pair of frequency values, and a second frequency shift relative to the base frequency in accordance with a second frequency shift value of the pair of frequency shift values, the second frequency shift value opposite to the first frequency shift value.

In some examples of the method, apparatuses, and non-transitory computer-readable medium described herein, decoding the WUS may include operations, features, means, or instructions for obtaining one or more bits of the first bit value based on the first bit value being mapped to a first subcarrier of a first resource block in accordance with a first subcarrier index and obtaining one or more bits of the second bit value based on the second bit value being mapped to a second subcarrier of the first resource block in accordance with a second subcarrier index and to a third subcarrier of the first resource block in accordance with a third subcarrier index.

In some examples of the method, apparatuses, and non-transitory computer-readable medium described herein, decoding the WUS may include operations, features, means, or instructions for obtaining one or more bits of the first bit value based on the first bit value being mapped to a first subcarrier of a first resource block in accordance with a first subcarrier index and obtaining one or more bits of the second bit value based on the second bit value being mapped to a second subcarrier of the first resource block in accordance with a second subcarrier index and to a third subcarrier of a second resource block in accordance with a third subcarrier index.

In some examples of the method, apparatuses, and non-transitory computer-readable medium described herein, monitoring for the WUS may include operations, features, means, or instructions for monitoring for the WUS during a WUS reception occasion of a set of WUS resources, where decoding the WUS may be based on monitoring for the WUS during the WUS reception occasion.

Some examples of the method, apparatuses, and non-transitory computer-readable medium described herein may further include operations, features, means, or instructions for monitoring for a set of multiple WUSs during a set of multiple WUS reception occasions based on the one or more parameters, the set of multiple WUSs including the WUS, where the one or more parameters indicate a periodicity for monitoring for the set of multiple WUSs during the set of multiple WUS reception occasions.

Some examples of the method, apparatuses, and non-transitory computer-readable medium described herein may further include operations, features, means, or instructions for transitioning a main radio of the UE from a sleep state to an active state based on a successful decoding of the WUS and in accordance with a transition time for activation of the main radio.

In some examples of the method, apparatuses, and non-transitory computer-readable medium described herein, the sleep state may be associated with a deactivation of one or more components associated with the main radio of the UE, of the wake-up radio, or both, where transitioning to the active state may include operations, features, means, or instructions for activating at least one component of the one or more components based on the transition time.

In some examples of the method, apparatuses, and non-transitory computer-readable medium described herein, the waveform type includes a frequency modulated waveform type and an amplitude of the frequency modulated waveform type may be based on the pair of frequency shift values.

In some examples of the method, apparatuses, and non-transitory computer-readable medium described herein, a size of the frequency shift may be greater than a size of a bandwidth associated with the WUS and the second bit value for obtaining the one or more bits may be based on the size of the frequency shift.

In some examples of the method, apparatuses, and non-transitory computer-readable medium described herein, the frequency shift may be based on an integer multiple of one or more of the pair of frequency shift values.

In some examples of the method, apparatuses, and non-transitory computer-readable medium described herein, the frequency shift may be based on a power of two multiple of one or more of the pair of frequency shift values.

In some examples of the method, apparatuses, and non-transitory computer-readable medium described herein, the one or more parameters indicate a quantity of frequency shifts relative to the base frequency in accordance with the pair of frequency shift values, a total bandwidth for the WUS including the base frequency and the pair of frequency shift values, or both.

A method for wireless communications at a UE is described. The method may include transmitting, to a network entity, a control signal indicating a transition time for activation of a main radio of the UE, where the transition time is based on a capability of the UE, receiving a second control signal indicating one or more gap values associated with one or more WUS reception occasions for monitoring for one or more WUSs, the one or more WUS reception occasions associated with a paging signal reception occasion for monitoring for a paging signal, monitoring, during a sleep state using a wake-up radio of the UE, for a WUS of the one or more WUSs during a first WUS reception occasion of the one or more WUS reception occasions based on a first gap value of the one or more gap values, and transitioning a main radio of the UE to an active state before the paging signal reception occasion based on reception of the WUS during the first WUS reception occasion and the indicated transition time.

An apparatus for wireless communications at a UE is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the UE to transmit, to a network entity, a control signal indicating a transition time for activation of a main radio of the UE, where the transition time is based on a capability of the UE, receive a second control signal indicating one or more gap values associated with one or more WUS reception occasions for monitoring for one or more WUSs, the one or more WUS reception occasions associated with a paging signal reception occasion for monitoring for a paging signal, monitor, during a sleep state using a wake-up radio of the UE, for a WUS of the one or more WUSs during a first WUS reception occasion of the one or more WUS reception occasions based on a first gap value of the one or more gap values, and transition a main radio of the UE to an active state before the paging signal reception occasion based on reception of the WUS during the first WUS reception occasion and the indicated transition time.

Another apparatus for wireless communications at a UE is described. The apparatus may include means for transmitting, to a network entity, a control signal indicating a transition time for activation of a main radio of the UE, where the transition time is based on a capability of the UE, means for receiving a second control signal indicating one or more gap values associated with one or more WUS reception occasions for monitoring for one or more WUSs, the one or more WUS reception occasions associated with a paging signal reception occasion for monitoring for a paging signal, means for monitoring, during a sleep state using a wake-up radio of the UE, for a WUS of the one or more WUSs during a first WUS reception occasion of the one or more WUS reception occasions based on a first gap value of the one or more gap values, and means for transitioning a main radio of the UE to an active state before the paging signal reception occasion based on reception of the WUS during the first WUS reception occasion and the indicated transition time.

A non-transitory computer-readable medium storing code for wireless communications at a UE is described. The code may include instructions executable by at least one processor (e.g., directly, indirectly, after pre-processing, without pre-processing) to transmit, to a network entity, a control signal indicating a transition time for activation of a main radio of the UE, where the transition time is based on a capability of the UE, receive a second control signal indicating one or more gap values associated with one or more WUS reception occasions for monitoring for one or more WUSs, the one or more WUS reception occasions associated with a paging signal reception occasion for monitoring for a paging signal, monitor, during a sleep state using a wake-up radio of the UE, for a WUS of the one or more WUSs during a first WUS reception occasion of the one or more WUS reception occasions based on a first gap value of the one or more gap values, and transition a main radio of the UE to an active state before the paging signal reception occasion based on reception of the WUS during the first WUS reception occasion and the indicated transition time.

In some examples of the method, apparatuses, and non-transitory computer-readable medium described herein, receiving the second control signal indicating the one or more gap values associated with the one or more WUS reception occasions may include operations, features, means, or instructions for receiving the control signal indicating the first gap value associated with the first WUS reception occasion and a second gap value of the one or more gap values, the second gap value associated with a second WUS reception occasion of the one or more WUS reception occasions, where monitoring for the WUS during the first WUS reception occasion may be based on the first gap value associated with the first WUS reception occasion being greater than the indicated transition time.

In some examples of the method, apparatuses, and non-transitory computer-readable medium described herein, the first gap value may be less than or equal to the second gap value and monitoring for the WUS during the first WUS reception occasion may be based on the first gap value being less than or equal to the second gap value.

In some examples of the method, apparatuses, and non-transitory computer-readable medium described herein, the first gap value may be greater than the second gap value and monitoring for the WUS during the first WUS reception occasion may be based on the first gap value being greater than the second gap value and the second gap value being less than or equal to the indicated transition time.

Some examples of the method, apparatuses, and non-transitory computer-readable medium described herein may further include operations, features, means, or instructions for receiving a timing offset indicator, where transitioning the main radio to the active state may be based on receiving the timing offset indicator.

In some examples of the method, apparatuses, and non-transitory computer-readable medium described herein, transitioning the main radio to the active state may include operations, features, means, or instructions for transitioning the main radio to the active state following the first WUS reception occasion based on a first value of the timing offset indicator.

In some examples of the method, apparatuses, and non-transitory computer-readable medium described herein, transitioning the main radio to the active state may include operations, features, means, or instructions for transitioning the main radio to the active state after a time offset following the first WUS reception occasion based on a second value of the timing offset indicator and a difference between the transition time and the first gap value satisfying a threshold.

In some examples of the method, apparatuses, and non-transitory computer-readable medium described herein, the timing offset indicator may be received within the WUS.

In some examples of the method, apparatuses, and non-transitory computer-readable medium described herein, the sleep state may be associated with a deactivation of one or more components associated with a main radio of the UE, of the wake-up radio, or both and transitioning the main radio to the active state includes activating at least one component of the one or more components based on the transition time.

In some examples of the method, apparatuses, and non-transitory computer-readable medium described herein, the transition time includes a time duration for transitioning the main radio to the active state and turning on the at least one component and may be based on a capability of the UE.

In some examples of the method, apparatuses, and non-transitory computer-readable medium described herein, the first gap value includes a time duration between the first WUS reception occasion and the paging signal reception occasion.

A method for wireless communications at a network entity is described. The method may include transmitting a control signal indicating a waveform type for a WUS for a UE and indicating one or more parameters for the WUS, where the one or more parameters indicate a base frequency for the WUS and a pair of frequency shift values associated with the WUS, generating the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS, and transmitting the WUS of the waveform type based on the generating.

An apparatus for wireless communications at a network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the network entity to transmit a control signal indicating a waveform type for a WUS for a UE and indicating one or more parameters for the WUS, where the one or more parameters indicate a base frequency for the WUS and a pair of frequency shift values associated with the WUS, generate the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS, and transmit the WUS of the waveform type based on the generating.

Another apparatus for wireless communications at a network entity is described. The apparatus may include means for transmitting a control signal indicating a waveform type for a WUS for a UE and indicating one or more parameters for the WUS, where the one or more parameters indicate a base frequency for the WUS and a pair of frequency shift values associated with the WUS, means for generating the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS, and means for transmitting the WUS of the waveform type based on the generating.

A non-transitory computer-readable medium storing code for wireless communications at a network entity is described. The code may include instructions executable by at least one processor (e.g., directly, indirectly, after pre-processing, without pre-processing) to transmit a control signal indicating a waveform type for a WUS for a UE and indicating one or more parameters for the WUS, where the one or more parameters indicate a base frequency for the WUS and a pair of frequency shift values associated with the WUS, generate the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS, and transmit the WUS of the waveform type based on the generating.

In some examples of the method, apparatuses, and non-transitory computer-readable medium described herein, the second bit value may be based on a first frequency shift relative to the base frequency in accordance with a first frequency shift value of the pair of the pair of frequency values, and a second frequency shift relative to the base frequency in accordance with a second frequency shift value of the pair of frequency shift values, the second frequency shift value opposite to the first frequency shift value.

In some examples of the method, apparatuses, and non-transitory computer-readable medium described herein, the first bit value for obtaining the one or more bits may be mapped to a first subcarrier of a first resource block based on a first subcarrier index and the second bit value for obtaining the one or more bits may be mapped to a second subcarrier of the first resource block based on a second subcarrier index and to a third subcarrier of the first resource block in accordance with a third subcarrier index.

In some examples of the method, apparatuses, and non-transitory computer-readable medium described herein, the first bit value for obtaining the one or more bits may be mapped to a first subcarrier of a first resource block based on a first subcarrier index and the second bit value for obtaining the one or more bits may be mapped to a second subcarrier of the first resource block based on a second subcarrier index and to a third subcarrier of a second resource block based on a third subcarrier index.

In some examples of the method, apparatuses, and non-transitory computer-readable medium described herein, transmitting the WUS may include operations, features, means, or instructions for transmitting the WUS during a WUS reception occasion of a set of WUS resources.

Some examples of the method, apparatuses, and non-transitory computer-readable medium described herein may further include operations, features, means, or instructions for transmitting a set of multiple WUSs during a set of multiple WUS reception occasions based on transmitting the control signal and generating the set of multiple WUSs, the set of multiple WUSs including the WUS, where the one or more parameters indicate a periodicity for monitoring for the set of multiple WUSs during the set of multiple WUS reception occasions.

In some examples of the method, apparatuses, and non-transitory computer-readable medium described herein, the WUS may be associated with a transition of a main radio of the UE from a sleep state to an active state based on a successful decoding of the WUS and a transition time for activation of the main radio.

In some examples of the method, apparatuses, and non-transitory computer-readable medium described herein, the sleep state may be associated with a deactivation of one or more components associated with the main radio of the UE, of a wake-up radio of the UE, or both and the transition of the main radio to the active state may be associated with an activation of at least one component of the one or more components based on the transition time.

In some examples of the method, apparatuses, and non-transitory computer-readable medium described herein, the waveform type includes a frequency modulated waveform type and an amplitude of the frequency modulated waveform type may be based on the pair of frequency shift values.

In some examples of the method, apparatuses, and non-transitory computer-readable medium described herein, a size of the frequency shift may be greater than a size of a bandwidth associated with the WUS and the second bit value for obtaining the one or more bits may be based on the size of the frequency shift.

In some examples of the method, apparatuses, and non-transitory computer-readable medium described herein, the frequency shift may be based on an integer multiple of one or more of the pair of frequency shift values.

In some examples of the method, apparatuses, and non-transitory computer-readable medium described herein, the frequency shift may be based on a power of two multiple of one or more of the pair of frequency shift values.

In some examples of the method, apparatuses, and non-transitory computer-readable medium described herein, the one or more parameters further indicate a quantity of frequency shifts relative to the base frequency in accordance with the pair of frequency shift values, a total bandwidth for the WUS including the base frequency and the pair of frequency shift values, or both.

A method for wireless communications at a network entity is described. The method may include receiving a control signal indicating a transition time for activation of a main radio of a UE, where the transition time is based on a capability of the UE, transmitting a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time, and transmitting, during a sleep state of the UE, a WUS during the first WUS reception occasion based on a first gap value of the one or more gap values, the first gap value associated with the first WUS reception occasion.

An apparatus for wireless communications at a network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the network entity to receive a control signal indicating a transition time for activation of a main radio of a UE, where the transition time is based on a capability of the UE, transmit a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time, and transmit, during a sleep state of the UE, a WUS during the first WUS reception occasion based on a first gap value of the one or more gap values, the first gap value associated with the first WUS reception occasion.

Another apparatus for wireless communications at a network entity is described. The apparatus may include means for receiving a control signal indicating a transition time for activation of a main radio of a UE, where the transition time is based on a capability of the UE, means for transmitting a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time, and means for transmitting, during a sleep state of the UE, a WUS during the first WUS reception occasion based on a first gap value of the one or more gap values, the first gap value associated with the first WUS reception occasion.

A non-transitory computer-readable medium storing code for wireless communications at a network entity is described. The code may include instructions executable by at least one processor (e.g., directly, indirectly, after pre-processing, without pre-processing) to receive a control signal indicating a transition time for activation of a main radio of a UE, where the transition time is based on a capability of the UE, transmit a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time, and transmit, during a sleep state of the UE, a WUS during the first WUS reception occasion based on a first gap value of the one or more gap values, the first gap value associated with the first WUS reception occasion.

In some examples of the method, apparatuses, and non-transitory computer-readable medium described herein, transmitting the second control signal indicating the one or more gap values associated with the one or more WUS reception occasions may include operations, features, means, or instructions for transmitting the second control signal indicating the first gap value associated with the first WUS reception occasion and a second gap value of the one or more gap values, the second gap value associated with a second WUS reception occasion of the one or more WUS reception occasions, where transmitting the WUS during the first WUS reception occasion may be based on the first gap value associated with the first WUS reception occasion being greater than the indicated transition time.

In some examples of the method, apparatuses, and non-transitory computer-readable medium described herein, the first gap value may be less than or equal to the second gap value and transmitting the WUS during the first WUS reception occasion may be based on the first gap value being less than or equal to the second gap value.

In some examples of the method, apparatuses, and non-transitory computer-readable medium described herein, the first gap value may be greater than the second gap value and transmitting the WUS during the first WUS reception occasion may be based on the first gap value being greater than the second gap value and the second gap value being less than or equal to the indicated transition time.

Some examples of the method, apparatuses, and non-transitory computer-readable medium described herein may further include operations, features, means, or instructions for transmitting a timing offset indicator indicating a first value or a second value, where transmitting the WUS during the first WUS reception occasion may be based on transmitting the timing offset indicator.

In some examples of the method, apparatuses, and non-transitory computer-readable medium described herein, the first value of the timing offset indicator may be associated with the active state and the second value of the timing offset indicator may be associated with a time offset, the active state, and a difference between the transition time and the first gap value satisfying a threshold.

In some examples of the method, apparatuses, and non-transitory computer-readable medium described herein, the timing offset indicator may be transmitted within the WUS.

In some examples of the method, apparatuses, and non-transitory computer-readable medium described herein, the sleep state may be associated with a deactivation of one or more components associated with a main radio of the UE, of a wake-up radio of the UE, or both and a transition of the main radio to the active state includes an activation of at least one component of the one or more components based on the transition time.

In some examples of the method, apparatuses, and non-transitory computer-readable medium described herein, the transition time includes a time duration for the transition of the main radio to the active state and for the at least one component to turn on, and may be based on a capability of the UE.

In some examples of the method, apparatuses, and non-transitory computer-readable medium described herein, the first gap value includes a time duration between the first WUS reception occasion and the paging signal reception occasion.

### BRIEF DESCRIPTION OF THE DRAWINGS

FIG. 1 shows an example of a wireless communications system that supports waveform generation for wake-up signals (WUSs) in accordance with one or more aspects of the present disclosure.

FIG. 2 shows an example of a wireless communications system that supports waveform generation for WUSs in accordance with one or more aspects of the present disclosure.

FIG. 3 shows an example of a wireless communications system that supports waveform generation for WUSs in accordance with one or more aspects of the present disclosure.

FIG. 4 shows an example of a frequency shift modulation diagram that supports waveform generation for WUSs in accordance with one or more aspects of the present disclosure.

FIGS. 5A and 5B show examples of subcarrier mapping diagrams that support waveform generation for WUSs in accordance with one or more aspects of the present disclosure.

FIG. 6 shows an example of a wireless communications system that supports waveform generation for WUSs in accordance with one or more aspects of the present disclosure.

FIG. 7 shows an example of a signaling diagram that supports waveform generation for WUSs in accordance with one or more aspects of the present disclosure.

FIG. 8 shows an example of a signaling diagram that supports waveform generation for WUSs in accordance with one or more aspects of the present disclosure.

FIG. 9 shows an example of a process flow that supports waveform generation for WUSs in accordance with one or more aspects of the present disclosure.

FIG. 10 shows an example of a process flow that supports waveform generation for WUSs in accordance with one or more aspects of the present disclosure.

FIGS. 11 and 12 show block diagrams of devices that support waveform generation for WUSs in accordance with one or more aspects of the present disclosure.

FIG. 13 shows a block diagram of a communications manager that supports waveform generation for WUSs in accordance with one or more aspects of the present disclosure.

FIG. 14 shows a diagram of a system including a device that supports waveform generation for WUSs in accordance with one or more aspects of the present disclosure.

FIGS. 15 and 16 show block diagrams of devices that support waveform generation for WUSs in accordance with one or more aspects of the present disclosure.

FIG. 17 shows a block diagram of a communications manager that supports waveform generation for WUSs in accordance with one or more aspects of the present disclosure.

FIG. 18 shows a diagram of a system including a device that supports waveform generation for WUSs in accordance with one or more aspects of the present disclosure.

FIGS. 19 through 22 show flowcharts illustrating methods that support waveform generation for WUSs in accordance with one or more aspects of the present disclosure.

### DETAILED DESCRIPTION

In wireless communications, a user equipment (UE) may utilize one or more power saving modes to conserve power. For example, a UE may enter a sleep state by deactivating one or more components (e.g., of one or more receivers or transmitters), including a main radio (e.g., when there is little or no data available for communication by the UE). The UE may also include a wake-up radio for receiving one or more wake-up signals (WUSs) during a sleep state, which, if received, may trigger the transition of one or more components (e.g., the main radio) to an active state (e.g., an ‘awake’ state). For example, the UE may monitor for and receive one or more WUSs during the sleep state (e.g., during one or more WUS reception occasions), and once a WUS is received, the UE may transition the main radio to an active state (e.g., the UE may activate one or more components associated with the main radio to support operations or communications using the main radio). In some cases, a WUS may be transmitted using an amplitude modulated waveform, such as an amplitude-shift keying (ASK) waveform, or a frequency modulated waveform, such as a frequency-shift keying (FSK) waveform. However, when receiving an FSK waveform WUS, a UE may utilize multiple parallel branches of modules or components (e.g., of a radio frequency (RF) chain) to decode the FSK waveform, which may increase a complexity of a receiver and a total power consumption at the UE. Additionally, or alternatively, multiple UEs with different transition times may monitor for receiving WUSs at one or more same WUS reception occasions. However, the WUS reception occasions may accommodate both transition times by implementing a longer gap before data reception, which may result in wasted power consumption at the UE due to early wake-up of the main radio.

A wireless communications system may support an FSK waveform type that is generated based on frequency shift modulation of a base signal to reduce a complexity of a corresponding receiver. For example, a network entity may map a zero bit value (e.g., ‘0’ for 1-bit FSK) to a base frequency, while mapping each additional bit value (e.g., ‘1’ for 1-bit FSK) to a corresponding frequency shift based on the base frequency and a pair of frequency shift values. The network entity may transmit bits of a WUS in a signal that is modulated according to the mapping. Due to the frequency shifting with the pair of frequency shift values, an amplitude of the FSK waveform may be modulated to allow the UE to implement a single branch receiver to receive the WUS, which may reduce a complexity of the receiver as well as reduce power consumption at the UE. In some examples, the FSK signal may be transmitted using different subcarriers of one or more resource blocks that are mapped to the different frequencies. Control signaling (e.g., Radio Resource Control (RRC)) may indicate the type of shifted FSK waveform so the UE may recognize and monitor for a waveform of the indicated type.

Additionally, or alternatively, the UE may receive a control signal indicating two different WUS reception occasions, and based on a capability of the UE and a corresponding transition time, the UE may select a WUS reception occasion to monitor for one or more WUSs. For example, the UE may select a later WUS reception occasion if the UE has a shorter transition time, thereby reducing a time the UE is awake and saving power. Additionally, or alternatively, the UE may monitor a same WUS regardless of capability or transition time, and may transition to a main radio to an active state immediately following the WUS reception occasion or after a delay based on an indication in the WUS.

Aspects of the disclosure are initially described in the context of wireless communications systems. Aspects of the disclosure are further illustrated by and described with reference to wireless communications systems, frequency shift modulation diagrams, subcarrier mapping diagrams, signaling diagrams, and process flows. Aspects of the disclosure are further illustrated by and described with reference to apparatus diagrams, system diagrams, and flowcharts that relate to waveform generation for WUSs.

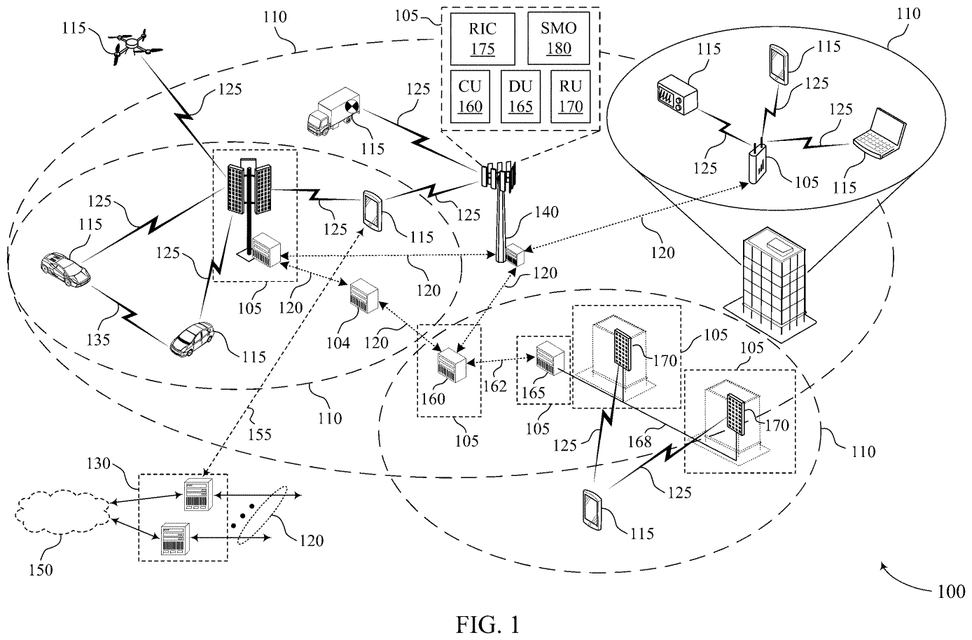

FIG. 1 shows an example of a wireless communications system 100 that supports waveform generation for WUSs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support waveform generation for WUSs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support an FSK waveform type that is generated based on frequency shift modulation of a base signal to reduce a complexity of a corresponding receiver. For example, a network entity 105 may map a zero bit value (e.g., ‘0’ for 1-bit FSK) to a base frequency, while mapping each additional non-zero bit value (e.g., ‘1’ for 1-bit FSK) to a corresponding frequency shift based on the base frequency and a pair of frequency shift values. The network entity 105 may transmit bits of a WUS in a signal to a UE 115 that is modulated according to the mapping. In some examples, the WUS may be transmitted using different subcarriers associated with one or more resource blocks that are mapped to the different frequencies. Control signaling (e.g., RRC) may also indicate the type of shifted FSK waveform so the UE 115 may recognize the amplitude modulated FSK waveform type. Additionally, or alternatively, the UE 115 may receive a control signal indicating two different WUS reception occasions, and based on a capability of the UE 115 and a corresponding transition time, the UE 115 may select a WUS reception occasion to monitor for one or more WUSs. For example, the UE 115 may select a later WUS reception occasion if the UE 115 has a shorter transition time. Additionally, or alternatively, the UE 115 may monitor a same WUS regardless of capability or transition time, and may transition to a main radio to an active state immediately following the WUS reception occasion or after a delay based on an indication in the WUS.

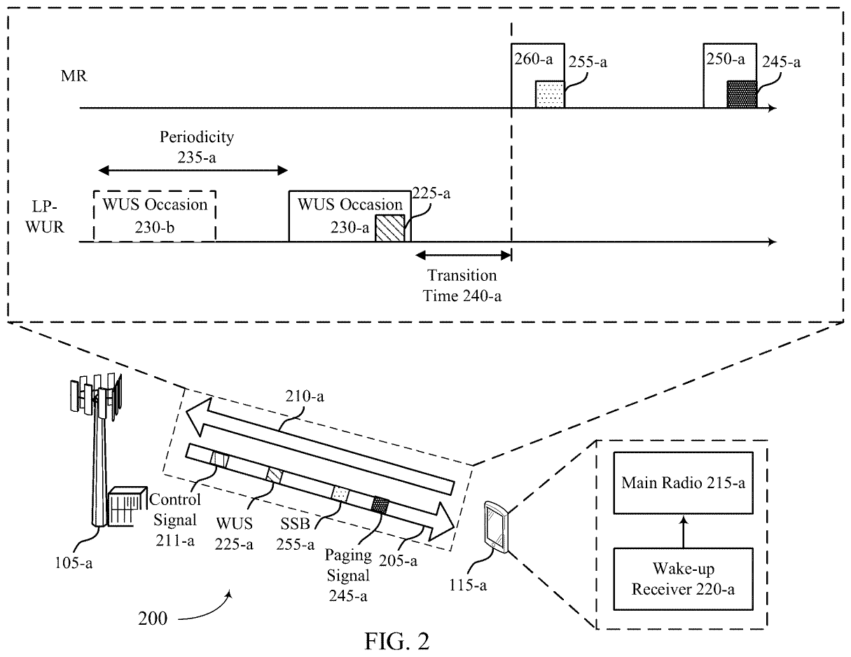

FIG. 2 shows an example of a wireless communications system 200 that supports waveform generation for WUSs in accordance with one or more aspects of the present disclosure. The wireless communications system 200 may illustrate an example for implementing one or more aspects of the wireless communications system 100. For example, the wireless communications system 200 may include a UE 115-a in communication with a network entity 105-a via a downlink communication link 205-a and an uplink communication link 210-a, which may represent a UE 115, a network entity 105, and one or more communication links 125 as described with respect to FIG. 1. In some examples, the UE 115-a may receive one or more control signals 211, such as the control 211-a, including information for configuring one or more parameters at the UE 115-a (e.g., an RRC signal). In some examples, the wireless communications system 200 may support frequency shift modulated signals and methods for allowing a UE to remain in a sleep state based on a transition time for a main radio of the UE as described herein.

In some examples, the UE 115-a may include a main radio 215-a (e.g., functioning as a main receiver, a main transmitter, main transceiver, or a combination thereof) and a wake-up receiver 220-a, and may support reception of one or more WUSs 225 for transitioning the main radio 215-a of the UE 115-a to an active state (e.g., “waking up” the main radio 215-a). For example, the UE 115-a may include the main radio 215-a for receiving or transmitting one or more signals to other communication devices (e.g., the network entity 105-a). The UE 115-a may include the wake-up receiver 220-a for receiving one or more WUSs while the UE 115-a is in a sleep state. In some cases, the wake-up receiver 220-a may be a companion receiver to the main radio 215-a, and may represent a low-power wake-up receiver (LP-WUR) for monitoring for WUSs 225 with low power consumption while the main radio is in sleep state (e.g., a “deep sleep state” or “ultra-deep sleep state”). In some examples, WUSs received using a low power (e.g., using the LP-WUR while the UE 115-a is in a sleep state) may be referred to as low power WUSs (LP-WUSs).

For example, during a time duration where the UE 115-a has little or no data to receive, the main radio 215-a may be “off” unless the UE 115-a has one or more signals to receive or transmit (e.g., if one or more transmissions are scheduled during the time duration). The main radio 215-a being “off” may represent a sleep state, where at least one component of the main radio 215-a may be deactivated. In some cases, the UE 115-a may be an example of an idle or inactive UE when the main radio 215-a is in a sleep state. During the sleep state, the wake-up receiver 220-a may remain active, and may continue active monitoring for one or more WUSs 225 (e.g., LP-WUSs). However, when there is data to receive (e.g., one or more transmissions are scheduled after the duration for the UE 115-a to receive), the UE 115-a may receive one or more WUSs 225 to transition the main radio 215-a to the active state. For example, the wake-up receiver 220-a may receive an on-demand (e.g., dynamic) LP-WUS that may activate the main radio 215-a, or that may trigger the UE 115-a to activate one or more components of the main radio 215-a. After the main radio 215-a is activated (e.g., in the active state), the UE 115-a may continue to receive (or transmit) data using the main radio 215-a. In some examples, one or more components of the wake-up receiver 220-a may be off during the sleep mode may also be activated after receiving a WUS 225.

In some examples, the wake-up receiver 220-a (e.g., an LP-WUR) may reduce a total power consumption and latency of communications. For example, the UE 115-a may avoid unnecessary transitions of the main radio 215-a to the active state, where the main radio 215-a may otherwise increase total power consumption (e.g., compared to the wake-up receiver 220-a). Additionally, as the wake-up receiver 220-a may consume less power in comparison to the main radio 215-a, the UE 115-a may allow frequent WUS monitoring to meet latency requirements. For example, the UE 115-a may transition the main radio 215-a to the active state after receiving dynamic WUSs to meet latency requirements while improving efficiency by transitioning the main radio 215-a to sleep states in between WUS reception. In some examples, sleep state operation described herein may present improvements over other scenarios, such as duty-cycling schemes (e.g., a static scheme where awake and sleep states are defined according to a periodicity).

In some examples, WUSs 225 may be used for paging monitoring, where LP-WUS reception may be to reduce unnecessary UE paging receptions. For example, one or more WUSs 225 may be transmitted if there is paging for idle or inactive mode UEs (e.g., when the UE 115-a is in a sleep state). In an example, the UE 115-a may monitor for one or more WUSs 225 during one or more WUS reception occasions 230 according to a WUS monitoring periodicity 235-a. At the WUS reception occasion 230-a, the UE 115-a may receive and detect a WUS 225-a indicating to transition the main radio 215-a to an active state. The UE 115-a may transition the main radio 215-a to the active state following a transition time 240-a of the UE 115-a in preparation of receiving a paging signal 245-a at a paging signal reception occasion 250. In some examples, once the main radio 215-a is in the active state, the UE 115-a may monitor for an SSB 255 during an SSB reception occasion 260 for synchronization before receiving a paging signal 245. For example, the UE 115-a may monitor for SSBs during the SSB reception occasion 260-a, and may receive the SSB 255-a indicating information for synchronization with the network entity 105-a. After the synchronization, the UE 115-a may monitor for and receive a paging signal 245-a during a paging signal reception occasion 250-a. In some cases, if a WUS 225 is not detected during a WUS reception occasion 230 (e.g., during the WUS reception occasion 230-b), the UE 115-a may refrain from transitioning the main radio 215-a to the active state and the main radio 215-a may remain in a sleep state to save power.

In some examples, a WUS 225 may include a 1-bit payload to indicate to transition the main radio 215-a to the active state. Additionally, or alternatively, a WUS 225 may include one or more bits including additional information, such as addressing information, among other signaling. For example, WUSs 225 may include message based WUSs where a WUS packet may include a preamble, a payload, and one or more cyclic redundancy check (CRC) bits. In some examples, the payload may include one or more bits indicating a cell identification number (ID) for cell identification or UE addressing for paging early indication. Additionally, or alternatively, WUSs 225 may be sequence-based WUSs, where the WUSs 225 may be based on one or more predefined sets of sequences dependent on cell ID and UE ID. A WUS 225 may be message-based or sequence based depending on an amount of information to transmit in a WUS 225.

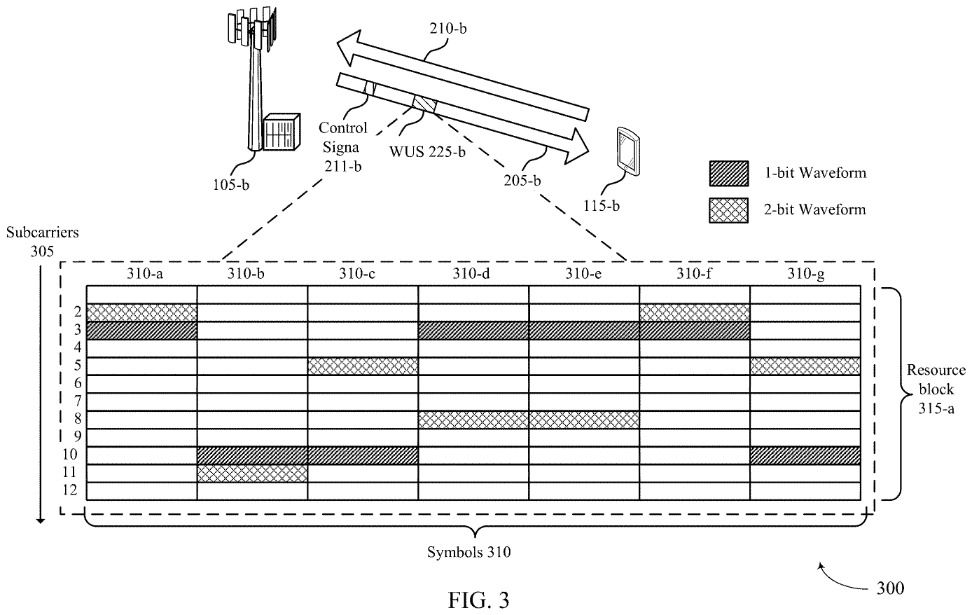

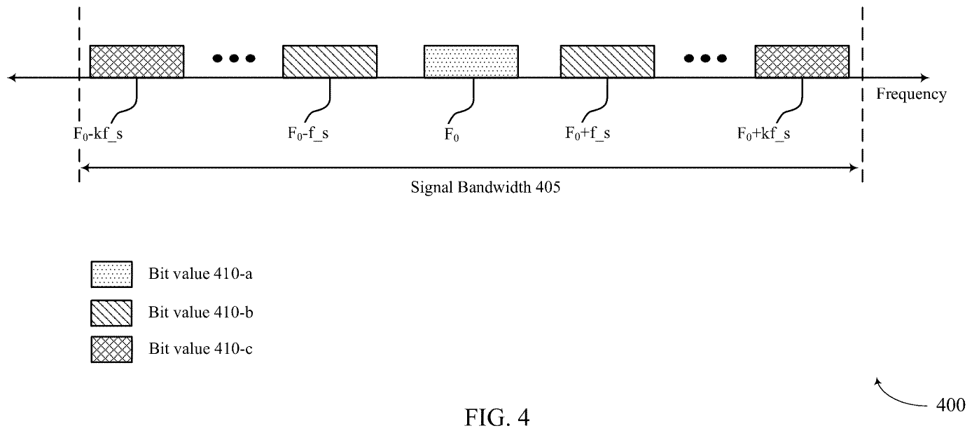

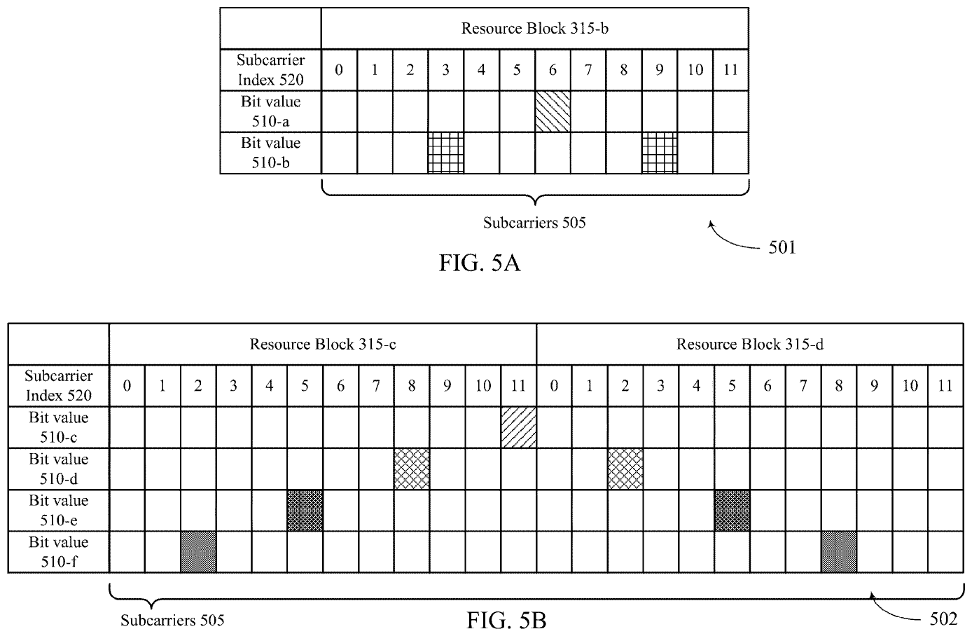

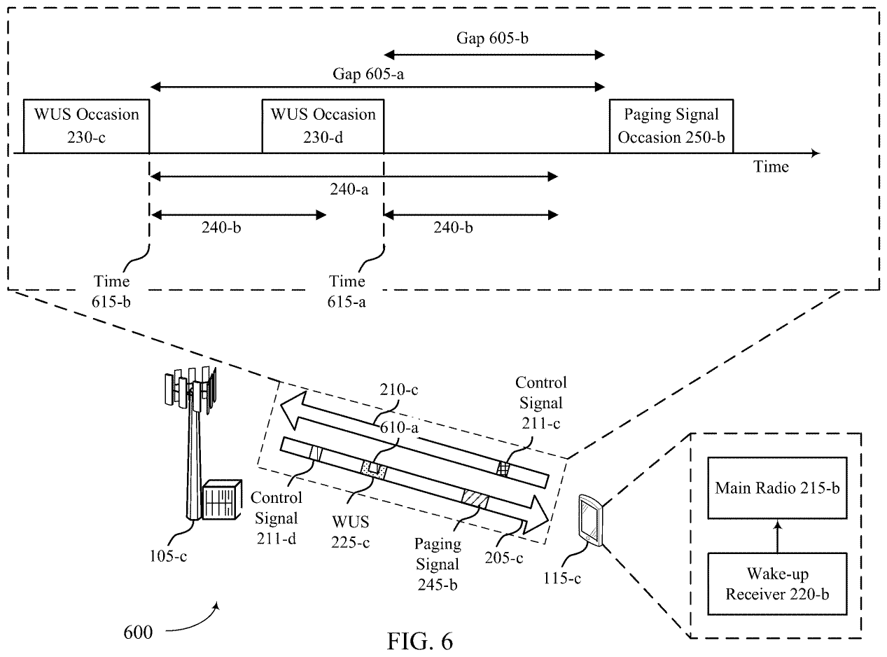

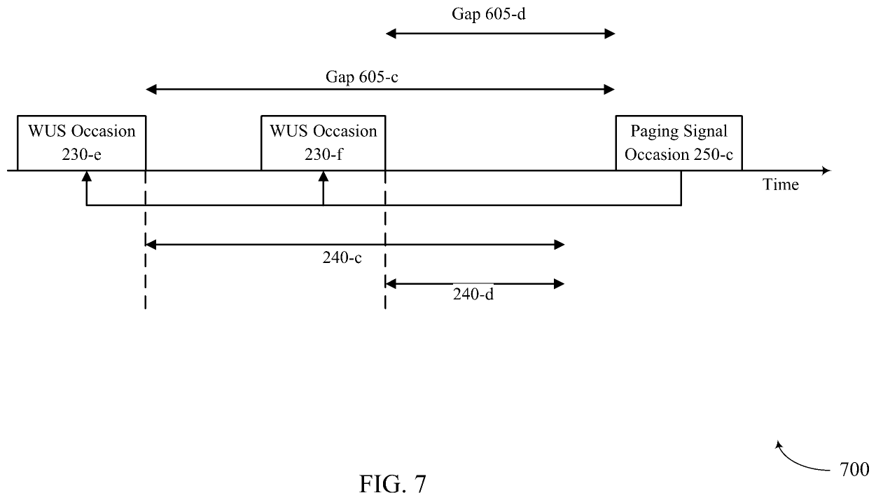

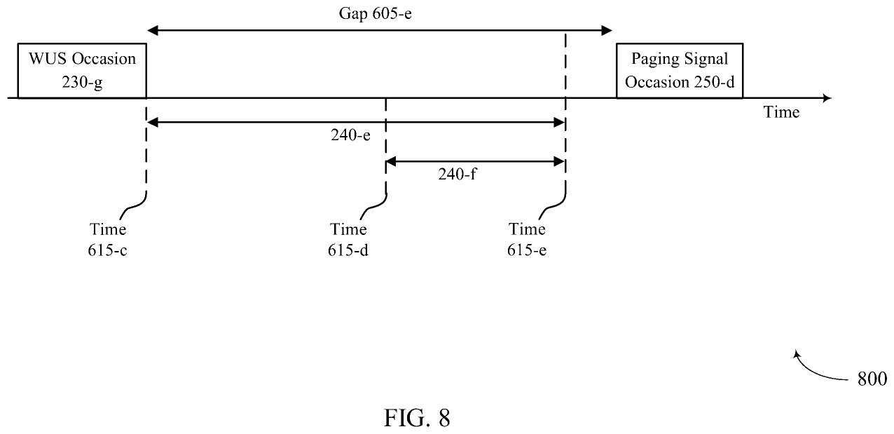

In some examples, the wireless communications system 200 may support an FSK waveform type that is generated based on frequency shift modulation of a base signal to reduce a complexity of a corresponding receiver. For example, the network entity 105-a may modulate an FSK waveform of the WUS 225-a according to a base frequency and one or more frequency shifts in relation to the base frequency and a pair of frequency shift values as described with respect to FIGS. 3 and 4. Additionally, or alternatively, the network entity 105-a may map the base frequency and frequency shifts to one or more subcarriers of one or more resource blocks as described with respect to FIGS. 5A and 5B. The wireless communications system may additionally support reducing an active time of the UE 115-a based on a transition time for the main radio 215-a of the UE 115-a. For example, the UE 115-a may monitor one of two WUS reception occasions based on a supported transition time for activating the main radio 215-a as described with respect to FIGS. 6 and 7. Additionally, or alternatively, the UE 115-a may postpone activation of the main radio 215-a according to an indicator in the WUS 225-a as described with respect to FIG. 8.

FIG. 3 shows an example of a wireless communications system 300 that supports waveform generation for WUSs in accordance with one or more aspects of the present disclosure. The wireless communications system 300 may illustrate an example for implementing one or more aspects of the wireless communications systems 100 and 200. For example, the wireless communications system 300 may include a UE 115-b in communication with a network entity 105-b via a downlink communication link 205-b and an uplink communication link 210-b, which may represent the UE 115-a, the network entity 105-a, the downlink communication link 205-a, and the uplink communication link 210-a described with respect to FIG. 2. The UE 115-a may similarly receive one or more WUSs from the network entity 105-b, including a WUS 225-b triggering the UE 115-b to transition a main radio 215 to an active state. In some examples, the wireless communications system 300 may support frequency shift modulated WUSs as described herein.

The wireless communications system 300 may support one or more different waveform types for WUSs. For example, the UE 115-b may support reception of ASK waveforms including multiple carrier ASK (MC-ASK) waveforms across multiple subcarriers 305 of a frequency spectrum or range (e.g., bandwidth). In some examples, an ASK waveform may represent one or more bits of information by modulating an amplitude of one or more carrier waves based on the one or more bits. Additionally, or alternatively, the UE 115-b may support FSK waveforms, including multiple carrier FSK (MC-FSK) across multiple subcarriers 305, where an FSK waveform may represent one or more bits by modulating the one or more bits across different frequencies of a carrier wave. The UE 115-b may receive the WUS 225-b according to an ASK waveform or an FSK waveform.

In some examples, for an FSK signal, a carrier of the FSK signal may have a total bandwidth including N subcarriers 305, where each subcarrier may span a subset of the total bandwidth (e.g., a subset of frequency ranges of a total frequency range). An FSK WUS waveform (or ASK waveform) may also be represented by M bits as a basic information unit. For example, a 1-bit waveform may modulate information to represent a ‘1’ or ‘0’ depending on a segment of the total bandwidth, where a segment may represent one or more subcarriers 305 of the N subcarriers. Similarly, a 2-bit waveform may modulate information to represent ‘00,’ ‘01,’ ‘10’, or ‘11,’ accordingly.

In some examples, the network entity 105-a may generate an FSK waveform for a WUS (e.g., LP-WUS) by separating N subcarriers into an integer quantity M of pairs of segments for modulation. For example, the WUS 225-b may be modulated across one or more symbols 310 of a resource block 315 as shown in FIG. 3, including symbols 310-a through 310-g. In some examples, the symbols 310 may represent one or more OFDM symbols. The resource block 315 may represent a physical resource block, and may include one or more subcarriers 305, including subcarriers 1, 2, 3, 4, 5, 6, 7, 8, 9, 10, 11, and 12. The network entity 105-b, for example, may modulate a signal for the WUS 225-b across the symbols 310 using two segments, where a first segment may include a subcarrier 3 and a second segment may include a subcarrier 10. The subcarrier 3 may represent a ‘0’ or a ‘1’, where the subcarrier 10 may represent the alternate value. One or more potential guard bands may be included around and in-between each segment of each pair, such as the subcarriers 1, 2, 4-9, 11, and 12. In some examples, in a pair of segments, one segment may modulated while the other segment may be zero power from a base-band point of view. Similarly, a 2-bit FSK waveform may include 2 pairs of segments.

By way of anther example, the network entity 105-a may generate an FSK waveform for a WUS (e.g., LP-WUS) by separating N subcarriers into 2^{M} individual segments for modulation. For example, for a 1-bit FSK waveform, the WUS 225-b may be modulated across the symbols 310-a through 310-f similar to the previous example. The WUS 225-b may be modulated according to 21=2 segments (for 1-bit FSK), and may include a first segment including subcarrier 3 and a second segment including subcarrier 10 of the resource block 315-a, where the subcarriers 3 and 10 may be used as candidate frequencies for data modulation. Similarly, subcarriers 1, 2, 11, and 12 may be used as guard bands (as well as subcarriers 4-9). In some examples, for a 2-bit FSK waveform modulation, subcarrier 2, 5, 8 and 11 may be used as four candidate frequencies for data modulation, while subcarriers 1 and 12 (as well as 3, 4, 6, 7, 9, and 10) may be used as guard bands. One segment from the 2^{M} segments may be modulated while other segments of subcarriers may be zero power from a base-band point of view.

In some examples, the UE 115-b may include a parallel envelope detector based receiver architecture for MC-FSK demodulation based on waveforms generated by the network entity 105-b. For example, the UE 115-b may include a receiver with 2^{M} parallel branches of modules. Each branch may include one or more bandpass filters, lowpass filters, envelope detectors, amplifiers, among other radio frequency and intermediate frequency modules for demodulating an M-bit FSK waveform of the WUS 225-b. However, although some modules may be shared between branches, having multiple parallel branches of modules may increase a receiver complexity and total power consumption at the UE 115-b. For example, having multiple parallel branches in a receiver may be less energy efficient when compared to a single branch receiver that may support receiving an ASK modulated waveform. Therefore, advanced techniques may be desired to reduce a quantity of branches of modules for demodulating an FSK waveform (e.g., for WUS signals).

As described herein, the wireless communications system 300 may support techniques for designing or generating an FSK waveform for WUS transmissions to avoid the use of multiple parallel branches of radio frequency (or intermediate frequency) modules in a receiver. For example, the network entity 105-b may generate an FSK waveform for the WUS 225-b based on a frequency shift modulation of a base signal as described with respect to FIG. 4 to support a single branch receiver at the UE 115-b. In some examples, the FSK waveform of the WUS 225-b may be mapped to one or more subcarriers 305 of one or more resource blocks 315. The network entity 105-b may also transmit a control signal 211-b to the UE 115-b (e.g., RRC or DCI) indicating the type of the waveform, among other information, to enable the UE 115-b to detect and decode the frequency shifted FSK waveform of the WUS 225-b.

FIG. 4 shows an example of a frequency shift modulation diagram 400 that supports waveform generation for WUSs in accordance with one or more aspects of the present disclosure. The frequency shift modulation diagram 400 may illustrate an example for implementing one or more aspects of the wireless communications systems 100, 200, and 300. For example, the frequency shift modulation diagram 400 may represent one or more signals of a waveform of the WUS 225-b transmitted by the network entity 105-b to the UE 115-b described with respect to FIG. 3. In some examples, the frequency shift modulation diagram 400 may illustrate generating an FSK waveform for the WUS 225-b based on a frequency shift modulation of a base signal as described herein.

For example, for an M-bit FSK waveform (e.g., MC-FSK), a total of 2^{M} pairs of frequency shifts may be applied to a base signal for representing one or more bits of the WUS 225-b. For example, within a total signal bandwidth 405, a base signal may be centered around a base frequency f₀. The base signal may be used to represent a bit value 410-a, which may be an example of a zero information bit value for an M-bit FSK. For example, the bit value 410-a may be a ‘0’ bit value for a 1-bit FSK waveform, a ‘00’ bit value for a 2-bit FSK waveform, or a ‘000’ bit value for a 3-bit FSK waveform. Various frequency shifts may be defined by a pair of frequency shift values (+kfₛ, −kfₛ) for k=0, 1, . . . , 2M−1, where the information bits of the WUS 225-b may be conveyed by transmitting signals using the base frequency and according to the 2^{M} pairs of frequency shifts. For example, a signal for a bit value 410-b (e.g., a potential bit value for a bit) may be defined by a first frequency f₀+fₛ shifted according to a first frequency shift value +fₛ, and a second frequency f₀−fₛ shifted according to a second frequency shift value−fₛ opposite to the first frequency value. For example, each frequency may be shifted according to a base frequency shift value fₛ, where the first frequency shift value +f may represent a “positive” shift to the right of the base frequency, and the second frequency shift value −fₛ may represent a “negative” shift to the left of the base frequency. That is, the first frequency shift value and the second frequency shift value may have a same absolute value (e.g., fₛ) but may have opposite sign values in relation to the base frequency f₀. The bit value 410-b may represent a next potential bit value for the FSK waveform, such as a ‘1’ for 1-bit FSK. Additionally, or alternatively, other non-zero information bit values 410 of the waveform may be defined by additional frequency shifts according to the base frequency shift value, including up to f₀+kfₛ and f₀−kfₛ, which may represent bit value 410-c, or a last potential bit value for the FSK waveform.

The FSK waveform may be represented by a combination of signals according to the frequency shifts described herein. For example, each signal corresponding to a potential bit value 410 may be represented by a superimposition of the corresponding pair of two frequency shifted signals (e.g., f₀+kfₛ and f₀−kfₛ), where the value of k is according to the bit value 410 for an information bit to be transmitted. In some examples, a transmitted signal sₖ(t) for each bit value 410 of a frequency shifted FSK waveform (e.g., of the WUS 225-b) may be given by Equation 1 below:

$${s}_{k} ( t ) = \frac{1}{2} {s}_{0} ( t ) ( {e}^{j 2 π {kf}_{s} t} + {e}^{- j 2 π {kf}_{s} t} ) = {s}_{0} ( t ) cos 2 π {kf}_{s} t \qquad ( 1 )$$

In Equation 1, sₖ(t) may represent the FSK waveform of the WUS 225-b at each bit value k of one or more bits values for representing the WUS 225-b. In some cases, s₀(t) may represent the base signal at the base frequency f₀. In some examples, the application of the frequency shifts according to Equation 1 to the FSK waveform of the WUS 225-b may modulate an amplitude of the FSK waveform. In other words, the FSK waveform of a WUS 225 may be converted to an amplitude modulated signal with an amplitude that is determined by kfₛ. In some cases, the signal bandwidth 405 may be based on Equation 1 and the frequency shift values f₀+kfₛ and f₀−kfₛ. Additionally, or alternatively, Equation 1 may be defined at the network entity 105-b for generating WUSs 225.

In some examples, the base frequency shift value fₛ may be configured to be larger than a signal bandwidth of the base signal so that the frequency location of the 2M frequency shifted signals do not overlap. For example, there may be a frequency gap between the signals for the bit values 410 as illustrated in FIG. 4. In some examples, the 2^{M} pairs of frequency shifts may be non-equally spaced following a power of two. For example, the signals for bit values 410 may be defined by f₀±fₛ, ±2fₛ, ±4fₛ, and ±8fₛ.

In some examples, the UE 115-b may include a single branch receiver for receiving the WUS 225-b according to Equation 1 and FIG. 4. For example, the UE 115-b may demodulate (e.g., decode) the WUS 225-b to obtain one or more bit values of the WUS 225-b using a single branch of radio frequency modules based on the amplitude modulated FSK signal of the WUS 225-b. By using a simpler receiver compared to a multiple branch receiver, the UE 115-b may reduce power consumption and improve a battery life of the UE 115-b when receiving one or more WUSs 225. Additionally, or alternatively, the UE 115-b may use a single branch receiver for receiving and demodulating one or more other signals transmitted according to the frequency shift modulation diagram 400 and Equation 1, as well as to demodulate other amplitude modulated signals accordingly (e.g., ASK waveform signals).

FIGS. 5A and 5B show examples of subcarrier mapping diagrams 501 and 502 that support waveform generation for WUSs in accordance with one or more aspects of the present disclosure. The subcarrier mapping diagrams 501 and 502 may illustrate examples for implementing one or more aspects of the wireless communications systems 100, 200, and 300 and the frequency shift modulation diagram 400. For example, the subcarrier mapping diagrams 501 and 502 may represent different subcarrier mappings of the frequency shifted signals for one or more bits of the WUS 225-b described with respect to FIG. 4. In some examples, the subcarrier mapping diagrams 501 and 502 may illustrate mapping one or more bit values 510 of an FSK waveform of the WUS 225-b to one or more subcarriers 505 within one or more resource blocks 315 to generate an FSK waveform (e.g., 1-bit FSK or 2-bit) as described herein.

FIG. 5A may illustrate a mapping for a 1-bit FSK waveform. For example, as described with respect to FIG. 4, signals for transmitting one or more bit values 510 of an FSK waveform for the WUS 225-b may be modulated according to pairs of frequency shift values each based on a base frequency shift value fₛ with respect to a base frequency f₀. In some cases, the 1-bit FSK waveform may be modulated according to a bit value 510-a, and a bit value 510-b, where the bit value 510-a may represent a ‘0’ bit corresponding to the base frequency f₀, and the bit value 510-b may represent a ‘1’ bit corresponding to a pair of frequency shift values +kfₛ and −kfₛ with respect to f₀, where k=1 for the 1-bit FSK waveform.

As illustrated in FIG. 5A, the FSK waveform may be mapped to one or more subcarriers 505 of a resource block 315-b corresponding to one or more subcarrier indexes 520. For example, the resource block 315-b may represent a physical resource block, and may include subcarriers 0-11 with corresponding indexes 0-11. The bit value 510-a (e.g., a base or zero bit value) may be mapped to a single subcarrier. For example, the bit value 510-a (e.g., ‘0’) may be mapped to the subcarrier index 6. Additional non-zero bit values may be mapped to two subcarriers each. For example, the bit value 510-b (e.g., ‘1’) may be mapped to a subcarrier pair including the subcarrier indexes 3 and 9 of the resource block 315-b. In some examples, additional subcarriers may be used as guard bands as described in FIG. 3, such as subcarriers 0-2, 10, and 11. Additionally, or alternatively, the subcarrier pair may be distributed evenly or unevenly across the resource block 315-b, and may include guard bands between used subcarriers 505 (e.g., subcarriers 4, 5, 7, and 8).

FIG. 5B may illustrate a mapping for a 2-bit FSK waveform. For example, the WUS 225-b may be modulated according to 2^{M} bit values as described with respect to FIG. 4, and may include potential bit values 510-c, 510-d, 510-e, and 510-f. In some cases, the bit values 510-c through 510-f may represent ‘00’, ‘01’, ‘10’, and ‘11’, respectively. The bit value 510-c may correspond to the base frequency f₀, and the bit values 510-d through 510-f may correspond to respective frequency shift values defined by f₀+kfₛ and f₀−kfₛ for three different values of k (e.g., incremental from 2 to 4, or based on a power of two as described herein).

For 2-bit FSK, the FSK waveform may be mapped to one or more subcarriers 505 of a resource block 315-c corresponding to one or more subcarrier indexes 520, to one or more subcarriers 505 of a resource block 315-d corresponding to one or more subcarrier indexes 520, or to subcarriers 505 of both resource blocks 315. For example, the resource block 315-c and 315-d may reach included include subcarriers 0-11 with corresponding indexes 0-11, which may represent one or more different or same subcarriers across the two resource blocks 315. The bit value 510-c (e.g., a base or zero bit value) may be mapped to a single subcarrier 505 of one resource block 315. For example, the bit value 510-c (e.g., ‘00’) may be mapped to the subcarrier index 11 of the resource block 315-c. In some examples, the non-zero bit values 510 (e.g., 510-d through 510-f) may be mapped to subcarrier pairs across both of the resource blocks 315-c and 315-d. For example, the bit value 510-d (e.g., ‘01’) may be mapped to the subcarrier index 8 of the resource block 315-c and the subcarrier index 2 of the resource block 315-d. The bit value 510-e (e.g., ‘10’) may be mapped to the subcarrier index 5 of the resource block 315-c and to the subcarrier index 5 of the resource block 315-d, and the bit value 510-f (e.g., ‘11’) may be mapped to the subcarrier index 2 of the resource block 315-c and to the subcarrier index 8 of the resource block 315-d. Additionally, or alternatively, the non-zero bit values 510 may be mapped to subcarriers of a single resource block 315. For example, the bit value 510-d may be mapped to two subcarrier indexes 520 of the resource block 315-c. Additionally, or alternatively, the bit values 510 may be mapped to any combination of subcarriers 505 with subcarrier indexes 520 in any combination of resource blocks 315. In some examples, the mapping illustrated in the subcarrier mapping diagrams 501 and 502 may be defined at the network entity 105-b for generating one or more WUSs 225.

FIG. 6 shows an example of a wireless communications system 600 that supports waveform generation for WUSs in accordance with one or more aspects of the present disclosure. The wireless communications system 600 may illustrate an example for implementing one or more aspects of the wireless communications systems 100, 200, and 300, the frequency shift modulation diagram 400, and the subcarrier mapping diagrams 501 and 502. For example, the wireless communications system 600 may include a UE 115-c in communication with a network entity 105-c via a downlink communication link 205-c and an uplink communication link 210-c, which may represent a UE 115, a network entity 105, a downlink communication link 205, and an uplink communication link 210 described with respect to FIGS. 2-4 and 5A and 5B. The UE 115-a may similarly receive one or more WUSs 225 from the network entity 105-b using a wake-up receiver 220-b, where the WUSs 225 may trigger the UE 115-c to transition a main radio 215-b of the UE 115-c to an active state. In some examples, the wireless communications system 600 may support methods to allow the UE 115-b to remain in a sleep state according to different transition times as described herein.

For example, the UE 115-b may include a transition time 240 (e.g., a ‘ramp-up time’ or ‘ramp-up transition time’) for transitioning the main radio 215-b of the UE 115-b to an active state as described with respect to FIG. 2. In some examples, the UE 115-b may include a transition time 240-a or a transition time 240-b based on a capability of the UE 115-b or for different use cases. For example, the UE 115-b may be an example of an advanced modem or UE (e.g., supporting enhanced mobile broadband (eMBB) communications), and may have a longer transition time 240-a (e.g., 800 ms) for activating one or more components of the main radio 215-b. Additionally, or alternatively, the UE 115-b may be an example of a simple UE with reduced capabilities, such as a RedCap UE, or an Internet of Things (IoT) device, and may have a shorter transition time 240-b (e.g., 400 ms) that is shorter than the transition time 240-a. In some cases, a size of a transition time 240 for the main radio 215-b may be dependent on a type of sleep state the UE 115-b is in (e.g., depending on how many components of a mixture of radios and receivers are deactivated). For example, a transition time for an “ultra-deep sleep” state (e.g., 400 ms or 800 ms) may be much longer than that of a lighter “deep-sleep” state (e.g., 20 ms), as an ultra-deep sleep state may involve a deactivation of a majority of hardware and software components of the UE 115-c (e.g., of the main radio 215-b, the wake-up receiver 220-b, or other components), whereas a “deep-sleep” state may involve a smaller quantity of deactivated components.

In some examples, the UE 115-c may monitor for WUSs 225 periodically as described with respect to FIG. 2. For example, the UE 115-c may include a WUS reception occasion 230-c separated from consecutive WUS reception occasions 230 by a periodicity 235. In some examples, for periodic WUS monitoring, locations of WUS reception occasions 230 (e.g., in the time domain) may be defined based on an associated paging signal reception occasion 250. For example, the UE 115-b may include a paging signal reception occasion 250-b, where a location of the WUS reception occasion 230-c may be defined so that a gap 605-a between the WUS reception occasion 230-c and the paging signal reception occasion 250-b is large enough to allow the UE 115-c to transition the main radio 215-b to an active state once a WUS 225 is received. For example, the gap 605-a for the WUS reception occasion 230-c may be based on the longer transition time 240-a being associated with the UE 115-c. Additionally, or alternatively, if the UE 115-c is associated with the shorter transition time 240-b, the network entity 105-b may instead transmit WUSs at a later WUS reception occasion 230-d according to the shorter transition time 240-b and a gap 605-b.

In some examples, more than one UE 115 may share one or more WUS reception occasions 230 and paging signal reception occasions 250. For example, the UE 115-c and another UE 115 may both be configured (e.g., by the network entity 105-c) to receive a paging signal 245 at the paging signal reception occasion 250-b after receiving one or more WUSs 225. However, the UE 115-c and the other UE 115 may have different transition times. For example, the UE 115-c may have the shorter transition time 240-b, while the other UE 115 may have the longer transition time 240-a. In some cases, when two UEs 115 sharing a same paging signal reception occasion have different transition times 240, a network entity 105 may transmit WUSs 225 (e.g., LP-WUSs during a sleep state) based on a longer transition time of the two UEs 115. For example, the network entity 105-b may transmit WUSs at the WUS reception occasion 230-c based on the gap 605-b being larger than the longer transition time 240-a of the other UE 115. However, the UE 115-c with the smaller transition time 240-b may transition the main radio 215-b to an active state long before the paging signal reception occasion 250-b, which may result in wasted power at the UE 115-c as the UE 115-c may remain in the active state to wait for the paging signal reception occasion 250-b.

As described herein, the wireless communications system 600 may support methods for the UE 115-c to remain in a sleep state according to different transition times. For example, the UE 115-c may transmit a control signal 211-c indicating a transition time associated with the UE 115-c, and may receive a control signal 211-d (e.g., RRC) indicating multiple configured WUS reception occasions 230. Based on a capability (e.g., transmission time 240) of the UE 115-c, the UE 115-c may select a WUS reception occasion 230 of multiple configured WUS reception occasions 230 as described with respect to FIG. 7. For example, the UE 115-c may select the WUS reception occasion 230-d to monitor for and receive a WUS 225-c based on the shorter transition time 240-b associated with the UE 115-c and the gap 605-b. Additionally, or alternatively, the UE 115-c may select the WUS reception occasion 230-c if the longer transition time 240-a is associated with the UE 115-c and based on the gap 605-a. Additionally, or alternatively, the UE 115-c may be configured with a single WUS reception occasion 230-c (e.g., via the control signal 211-d), and may transition the main radio 215-b at an offset following the WUS reception occasion 230-c based on a capability of the UE 115-c as described with respect to FIG. 8. For example, the UE 115-c may transition the main radio 215-b at a time 615-a following the WUS reception occasion 230-c based on the UE 115-c being associated with the shorter transition time 240-b and an indicator 610-a. Additionally, or alternatively, the UE 115-c may transition the main radio at a time 615-b following the WUS reception occasion 230-c if the UE 115-c is associated with the longer transition time 240-a. Based on the transition of the main radio, the UE 115-c may monitor for and receive a paging signal 245-b during the paging signal reception occasion 250-b.

FIG. 7 shows an example of a signaling diagram 700 that supports waveform generation for WUSs in accordance with one or more aspects of the present disclosure. The signaling diagram 700 may illustrate an example for implementing one or more aspects of the wireless communications systems 100, 200, 300, and 600, the frequency shift modulation diagram 400, and the subcarrier mapping diagrams 501 and 502. For example, the signaling diagram 700 may illustrate the UE 115-c monitoring for and receiving one or more WUSs 225 during one or more WUS reception occasions 230 configured according to gaps 605 and an associated paging signal reception occasion 250 as described with respect to FIG. 6. In some examples, the signaling diagram 700 may illustrate a configuration of different WUS reception occasions 230 for use according to different UE transition times 240.

For example, the UE 115-c may transmit a control signal 211 (e.g., the control signal 211-c) to the network entity 105-c to indicate a transition time 240 associated with the UE 115-c. In some cases, the UE 115-c may transmit the control signal 211 to indicate a longer transition time 240-c or a shorter transition time 240-d, where the indicated transition time 240 may be based on a capability of the UE 115-c. In some examples, the control signal 211 may be part of a capability message transmitted by the UE 115-c indicating one or more additional capabilities of the UE 115-c.

In some cases, the network entity 105-c may group one or more UEs into one or more subgroups for WUS monitoring based on the indicated transition time from the UE 115-c as well as additional indicated transition times from other UEs 115. For example, the network entity 105-c may configure one or more a single paging signal reception occasion 250 with multiple WUS resources (e.g., WUS reception occasions 230) with different time offsets to associated paging signal reception occasions. For example, based on an indicated transition time 240-c, the network entity 105-c may determine a gap 605-c between a WUS reception occasion 230-e and a paging signal occasion 250-c and may determine a first group of UEs 115 associated with the transition time 240-c, the WUS reception occasion 230-e, and the gap 605-c.

Additionally, or alternatively, based on an indicated transition time 240-d, the network entity 105-c may determine a gap 605-d between a WUS reception occasion 230-f and the paging signal occasion 250-c, and may determine a second group of UEs 115 associated with the transition time 240-d, the WUS reception occasion 230-f, and the gap 605-d. In some cases, the transition times 240-c and 240-d may represent maximum transition times for wakeup of, or for transitioning a main radio 215 to an active state. Additionally, or alternatively, the gaps 605-c and 605-d may represent minimum gaps between a corresponding WUS reception occasion 230 and an associated paging signal reception occasion 250. In some cases, the WUS reception occasions 230-e and 230-f and the paging signal reception occasion 250-c may be configured according to a periodicity for periodic WUS monitoring.

In some examples, the UE 115-c may receive a second control signal 211 (e.g., the control signal 211-d) from the network entity 105-c to configure one or more parameters for WUS monitoring. For example, the UE 115-c may receive an RRC signal including one or more parameters to indicate the gap 605-c and the gap 605-d for the WUS reception occasions 230-e and 230-f, respectively. In some cases, the UE 115-c may determine a stat time for the WUS reception occasions 230-e and 230-f based on the indicated gaps 605. In some examples, the RRC signal may also indicate the one or more WUS reception occasions 230-e and 230-f, or may indicate a time to start the WUS reception occasions 230 and a duration for which to monitor for WUSs 225 during the WUS reception occasions 230. In some cases, the network entity 105-c may transmit the control signal 211 based on determining the groups of UEs 115. In some examples, the UE 115-c may be preconfigured with paging signal reception occasions 250 based on a capability of the UE 115-c, where a paging signal reception occasion 250 may be based on an identification number of the UE 115-c and a paging configuration (e.g., received via the RRC signal).

The UE 115-c may determine or select a WUS reception occasion 230 based on the indicated transition time (e.g., based on the reported maximum transition time for the main from an ultra-deep sleep state). For example, if the UE 115-c is associated with the longer transition time 240-c, the UE 115-c may select the WUS reception occasion 230-e and may monitor for receiving one or more WUSs 225 during the WUS reception occasion 230-e accordingly. If a WUS 225 is received during the WUS reception occasion 230-e, the UE 115-c may transition the main radio 215-b to the active state after an end of the WUS reception occasion 230-e so that the main radio is in the active state following the transition time 240-c and before the paging signal reception occasion 250-c. Additionally, or alternatively, if the UE 115-c is associated with the shorter transition time 240-d, the UE 115-c may select the WUS reception occasion 230-f, may monitor for and receive one or more WUSs 225 during the WUS reception occasion 230-f, and may transfer to the main radio 215-b to the active state accordingly. In some cases, the network entity 105-c may configure the paging signal occasion 250-c with additional WUS reception occasions 230 (e.g., in an N-to-1 ratio of WUS reception occasions 230 to paging signal reception occasions 250), where the UE 115-c may select any of the WUS reception occasions to monitor based on a transition time 240 of the UE 115-c.

In some examples, the UE 115-c may conserve power by selecting a WUS reception occasion 230 to monitor based on a transition time 240 of the UE 115-c and by transitioning the main radio 215 following the selecting WUS reception occasion 230. For example, transitioning the main radio 215-b following the WUS reception occasion 230-f may reduce an amount of time that the main radio 215-b is in the active state compared to transitioning the main radio 215-b following the WUS reception occasion 230-e and before the WUS reception occasion 230-f.

FIG. 8 shows an example of a signaling diagram 800 that supports waveform generation for WUSs in accordance with one or more aspects of the present disclosure. The signaling diagram 800 may illustrate an example for implementing one or more aspects of the wireless communications systems 100, 200, 300, and 600, the frequency shift modulation diagram 400, the subcarrier mapping diagrams 501 and 502, and the signaling diagram 700. For example, the signaling diagram 800 may illustrate the UE 115-c monitoring for and receiving one or more WUSs 225 during one or more WUS reception occasions 230 configured according to gaps 605 and an associated paging signal reception occasion 250. In some examples, the signaling diagram 800 may illustrate the UE 115-c transitioning the main radio 215-b at an offset following a single configured WUS reception occasion 230-c based on a capability of the UE 115-c.

For example, the network entity 105-c may configure the UE 115-c (and one or more other UEs 115) with a single WUS reception occasion 230-g associated with a single paging signal reception occasion 250-d. In some examples, the WUS reception occasion 230-g and the paging signal reception occasion 250-d may be configured according to a periodicity for periodic WUS monitoring. In some cases, as described with respect to FIGS. 6 and 7, the UE 115-c may receive a control signal 211 (e.g., RRC) indicating the WUS reception occasion 230-g and the paging signal occasion 250-d, as well as a gap 605-e between the WUS reception occasion 230-g and the paging signal reception occasion 250-d. The network entity 105-c may refrain from grouping the UE 115-c and one or more other UEs 115 into subgroups based on associated transition times 240. In some examples, the UE 115-c may be associated with a longer transition time 240-e or a shorter transition time 240-f as described herein with respect to FIG. 1-7. Additionally, or alternatively, the UE 115-c may transmit a control signal 211 to indicate a supported transition time 240 of the UE 115-c.

In some examples, the UE 115-c may transition the main radio 215-b based on a transition time 240 of the UE 115-c and an indicator 610 received from the network entity 105-c. For example, the UE 115-c may monitor for one or more WUSs 225 during the WUS reception occasion 230-g and may receive a WUS 225. In some examples, a timing offset indicator 610 may be included within the received WUS 225 to dynamically indicate a timing offset for main radio wake-up. The indicator 610 may be a 1-bit indicator, where a ‘0’ value may indicate to a UE 115 that receives the indicator to transition a corresponding main radio 215 immediately or soon following the WUS reception occasion 230-g. For example, the UE 115-c and each UE 115 monitoring the WUS reception occasion 230-g may receive the WUS 225, and may transition the main radio 215-b at a time 615-c immediately following the WUS reception occasion 230-g based on a ‘0’ value indicator in the WUS 225. In some examples, a ‘0’ may target (e.g., be sent to or trigger) UEs 115 with longer transition times 240-e. Additionally, or alternatively, the indication 610 may target (e.g., be sent to or trigger) both types of UEs 115 regardless of transition time (e.g., associated with both the longer transition time 240-e and the shorter transition time 240-f).

In some examples, a bit value of ‘1’ of the timing offset indicator 610 may indicate that UEs 115-c associated with the smaller transition time 240-f may postpone main radio wake-up by a time duration. For example, the UE 115-c may be associated with the shorter transition time 240-f, and based on a ‘1’ indication received in a WUS 225 during the WUS reception occasion 230-g, the UE 115-c may delay transitioning the main radio 215-b until a time 615-d. In some examples, the time 615-d may be determined based on a difference between the gap 605-e and a supported transition time 240 of the UE 115-c (e.g., reported or indicted to the network entity 105-c) satisfying (e.g., greater than or equal to) a threshold. For example, the UE 115-c may determine that a difference between the gap 605-e and the transition time 240-f is greater than a threshold, and may proceed to postpone the transition of the main radio accordingly. For example, the UE 115-c may wake the main radio at the time 615-d and finish the transition at a time 615-e, where the time 615-e may be before or at a start of the paging signal occasion 250-d. Additionally, or alternatively, if the UE 115-c is associated with the transition time 240-e and determines that the difference fails satisfy the threshold, the UE 115-c may transition the main radio at the time 615-c. In some cases, the UE 115-c may refrain from transitioning the main radio if the bit value is a ‘1’ and the difference fails to satisfy the threshold.

Thus, the time 615-c may represent a start time for a transition of a main radio for UEs 115 with a longer transition time, while the time 615-d may represent a start time for a transition of a main radio for UEs 115 with a shorter transition time, where a main radio may be active (e.g., ON) at the time 615-e. In some examples, by postponing the transition of the main radio until the time 615-d, the UE 115-c may conserve power. For example, the UE 115-c may reduce an amount of the time the main radio 215-b is in the active state by keeping the main radio 215-b in the sleep state before the time 615-d. In some cases, the UE 115-c may apply the operations described herein with respect to delaying main radio transition to different reception occasions for other signals (e.g., besides WUS and paging signals) to reduce power consumption.

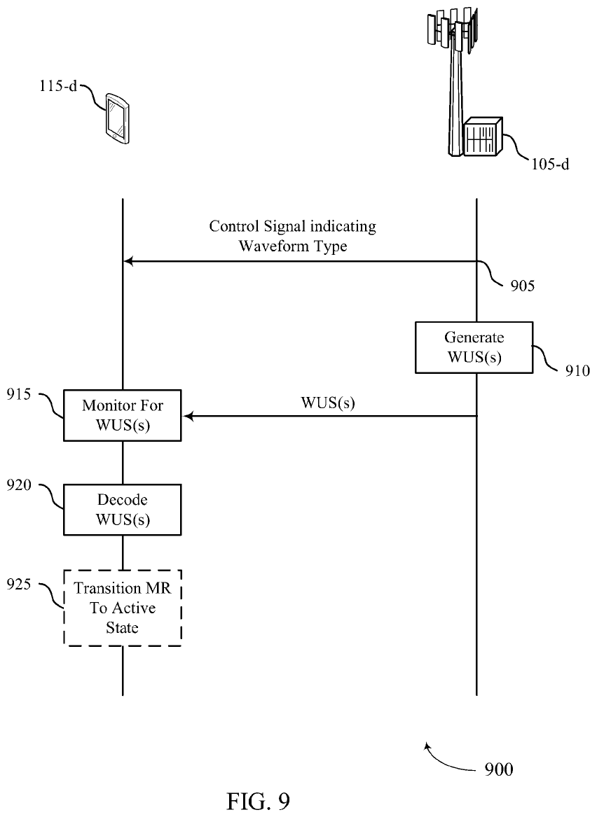

FIG. 9 shows an example of a process flow 900 that supports waveform generation for WUSs in accordance with one or more aspects of the present disclosure. In some examples, the process flow 900 may implement aspects of the wireless communications systems 100, 200, 300, and 600, the frequency shift modulation diagram 400, the subcarrier mapping diagrams 501 and 502, and the signaling diagrams 700 and 800. For example, the process flow 900 may illustrate an example of a network entity 105-d in communication with a UE 115-c using a downlink communication link 205 and an uplink communication link 210, which may represent one or more network entities 105 and UEs 115 described with respect to FIGS. 1-8. In some examples, the process flow 900 may illustrate methods for frequency shift modulated WUSs as described herein and with respect to FIGS. 2-4, 5A, and 5B.

Alternative examples of the following may be implemented, where some processes are performed in a different order than described or are not performed. In some cases, processes may include additional features not mentioned below, or further processes may be added.

At 905, the UE 115-d may receive, and the network entity 105-d may transmit, a control signal indicating a waveform type for a WUS for the UE 115-d, as well as indicating one or more parameters for the waveform type. In some examples, the one or more parameters may indicate a base frequency for the WUS and a pair of frequency shift values associated with the WUS. Additionally, or alternatively, the one or more parameters may indicate a quantity of frequency shifts relative to the base frequency in accordance with the pair of frequency shift values, a total bandwidth for the WUS including the base frequency and the pair of frequency shift values, or both. In some examples, the waveform type may include a frequency modulated waveform type, where an amplitude of the frequency modulated waveform type is based on the pair of frequency shift values.

At 910, the network entity 105-d may generate the WUS of the waveform type based on transmitting the control signal and encoding one or more bits of the WUS. In some examples, a first bit value for encoding the one or more bits may be based on the base frequency and a second bit value for encoding the one or more bits may be based on a frequency shift relative to the base frequency in accordance with the pair of frequency shift values for the WUS.

At 915, the UE 115-d may use a wake-up radio of the UE to monitor for, and the network entity 105-d may transmit, the WUS of the waveform type based on the one or more parameters and the generating. In some cases, the WUS may be transmitted during a WUS reception occasion of a set of WUS resources, where decoding the WUS may be based on monitoring for the WUS during the WUS reception occasion. In some cases, the UE 115-d may monitor for, and the network entity 105-d may transmit, a set of multiple of WUSs during a set of multiple of WUS reception occasions based on the one or more parameters, the set of multiple of WUSs including the WUS. In some examples, the one or more parameters may indicate a periodicity for monitoring for the set of multiple of WUSs during the set of multiple of WUS reception occasions. In some examples, the set of multiple of WUSs may be transmitted during the set of multiple of WUS reception occasions based on transmitting the control signal and generating the set of multiple of WUSs.

At 920, the UE 115-d may decode the WUS to obtain one or more bits of the WUS based on the monitoring, where the first bit value and the second bit value may be used for obtaining the one or more bits. In some examples, decoding the WUS may include obtaining one or more bits associated with the second bit value based on a first frequency shift relative to the base frequency in accordance with a first frequency shift value of the pair of frequency values, and a second frequency shift relative to the base frequency in accordance with a second frequency shift value of the pair of frequency shift values, where the second frequency shift value may be opposite to the first frequency shift value.

Additionally, or alternatively, decoding the WUS may include obtaining one or more bits of the first bit value based on the first bit value being mapped to a first subcarrier of a first resource block in accordance with a first subcarrier index, and obtaining one or more bits of the second bit value based on the second bit value being mapped to a second subcarrier of the first resource block in accordance with a second subcarrier index and to a third subcarrier of the first resource block in accordance with a third subcarrier index. In some examples, decoding the WUS may include obtaining one or more bits of the first bit value based on the first bit value being mapped to a first subcarrier of a first resource block in accordance with a first subcarrier index, and obtaining one or more bits of the second bit value based at least in part on the second bit value being mapped to a second subcarrier of the first resource block in accordance with a second subcarrier index and to a third subcarrier of a second resource block in accordance with a third subcarrier index.

In some cases, a size of the frequency shift may be greater than a size of a bandwidth associated with the WUS, where the second bit value is based on the size of the frequency shift. Additionally, or alternatively, the frequency shift may be based on an integer multiple of one or more of the pair of frequency shift values. In some examples, the frequency shift may be based on a power of two multiple of one or more of the pair of frequency shift values.

At 925, the UE 115-d may optionally transition a main radio of the UE from a sleep state to an active state based on a successful decoding of the WUS and in accordance with a transition time for activation of the main radio, where the WUS may be associated with the transition. Additionally, or alternatively, the sleep state may be associated with a deactivation of one or more components associated with the main radio of the UE, of the wake-up radio, or both, where transitioning to the active state may include activating at least one component of the one or more components based on the transition time.

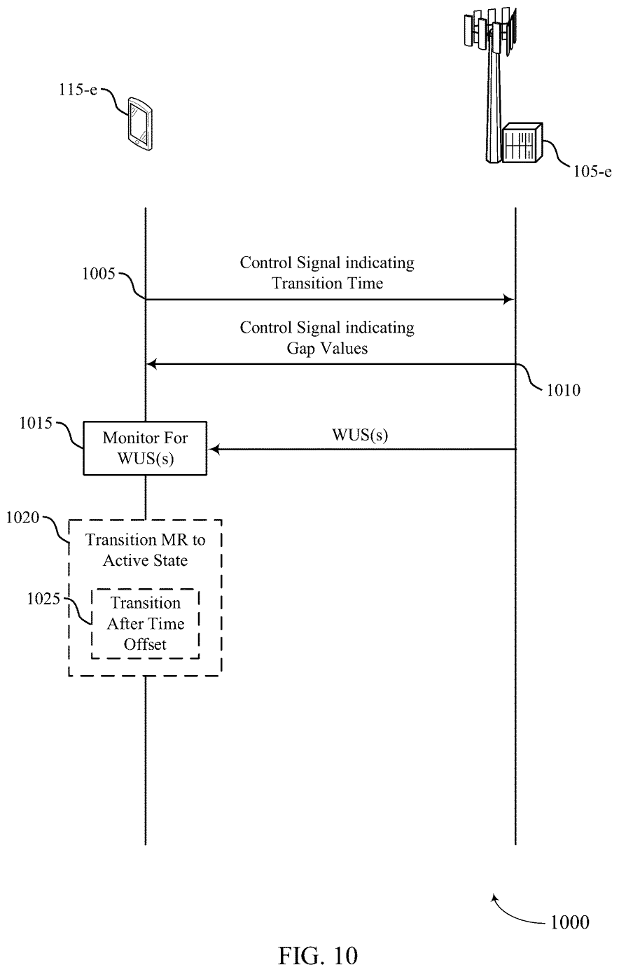

FIG. 10 shows an example of a process flow 1000 that supports waveform generation for WUSs in accordance with one or more aspects of the present disclosure. In some examples, the process flow 1000 may implement aspects of the wireless communications systems 100, 200, 300, and 600, the frequency shift modulation diagram 400, the subcarrier mapping diagrams 501 and 502, the signaling diagrams 700 and 800, and the process flow 900. For example, the process flow 1000 may illustrate an example of a network entity 105-e in communication with a UE 115-e using a downlink communication link 205 and an uplink communication link 210, which may represent one or more network entities 105 and UEs 115 described with respect to FIGS. 1-9. In some examples, the process flow 1000 may illustrate methods to allow the UE 115-e to remain in a sleep state according to different transition times as described herein and with respect to FIGS. 6-8.

Alternative examples of the following may be implemented, where some processes are performed in a different order than described or are not performed. In some cases, processes may include additional features not mentioned below, or further processes may be added.

At 1005, the UE 115-e may transmit, and the network entity 105-e may receive, a control signal indicating a transition time for activation of a main radio of the UE 115-e, where the transition time may be based on a capability of the UE 115-e. In some examples, the transition time may include a time duration for transitioning the main radio to the active state and turning on the at least one component and is based on a capability of the UE.

At 1010, the network entity 105-e may transmit, and the UE 115-e may receive, a second control signal indicating one or more gap values associated with one or more WUS reception occasions for monitoring for one or more WUSs, where the one or more WUS reception occasions may be associated with a paging signal reception occasion for monitoring for a paging signal. In some examples, receiving the second control signal indicating the one or more gap values associated with the one or more WUS reception occasions may include receiving the control signal indicating the first gap value associated with the first WUS reception occasion and a second gap value of the one or more gap values. In some cases, the second gap value may be associated with a second WUS reception occasion of the one or more WUS reception occasions.

At 1015, the UE 115-e may use a wake-up radio of the UE to monitor for, and the network entity 105-e may transmit, during a sleep state, a WUS of the one or more WUSs during a first WUS reception occasion of the one or more WUS reception occasions based on a first gap value of the one or more gap values, the first gap value associated with the first WUS reception occasion. In some examples, the first gap value may include a time duration between the first WUS reception occasion and the paging signal reception occasion.

In some examples, the first gap value may be less than or equal to the second gap value, where monitoring for the WUS during the first WUS reception occasion may be based on the first gap value being less than or equal to the second gap value. By way of another example, the first gap value may be greater than the second gap value, where monitoring for the WUS during the first WUS reception occasion may be based on the first gap value being greater than the second gap value and the second gap value being less than or equal to the indicated transition time. In some examples, the transmission of the WUS during the first WUS reception occasion may be based on the first gap value associated with the first WUS reception occasion being greater than the indicated transition time

In some examples, the UE 115-e may receive, and the network entity 105-e may transmit, a timing offset indicator. In some examples, the timing offset indicator is received within the WUS.

At 1020, the UE 115-e may optionally transition the main radio of the UE to an active state before the paging signal reception occasion based on reception of the WUS during the first WUS reception occasion and the indicated transition time. In some examples, the first WUS reception occasion of the one or more WUS reception occasions is associated with the active state and the indicated transition time.

In some examples, transitioning the main radio to the active state may include transitioning the main radio to the active state following the first WUS reception occasion based on receiving the timing offset indicator, or based on a first value of the timing offset indicator.

Additionally, or alternatively, transitioning the main radio to the active state may include transitioning the main radio to the active state after a time offset following the first WUS reception occasion based on a second value of the timing offset indicator and a difference between the transition time and the first gap value satisfying a threshold. For example, at 1025, the UE 115-e may transition the main radio to the active state after the time offset.

In some examples, the first value of the timing offset indicator may be associated with the active state, where the second value of the timing offset indicator may be associated with the time offset, the active state, and the difference between the transition time and the first gap value satisfying a threshold. In some examples, the sleep state may be associated with a deactivation of one or more components associated with the main radio of the UE, of the wake-up radio, or both, where transitioning the main radio to the active state may include activating at least one component of the one or more components based on the transition time.

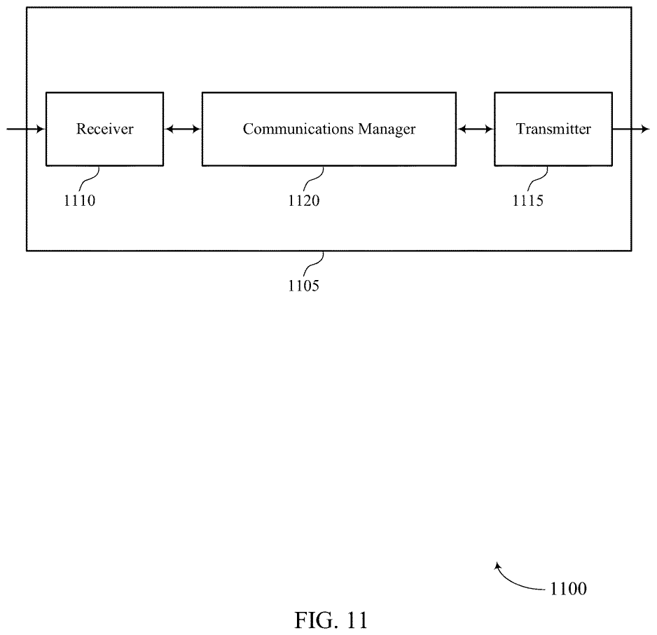

FIG. 11 shows a block diagram 1100 of a device 1105 that supports waveform generation for WUSs in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to waveform generation for WUSs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to waveform generation for WUSs). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of waveform generation for WUSs as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. For example, the communications manager 1120 is capable of, configured to, or operable to support a means for receiving a control signal indicating a waveform type for a WUS for the UE and indicating one or more parameters for the waveform type, where the one or more parameters indicate a base frequency for the WUS and a pair of frequency shift values associated with the WUS. The communications manager 1120 is capable of, configured to, or operable to support a means for monitoring, using a wake-up radio of the UE, for the WUS of the waveform type based on the one or more parameters. The communications manager 1120 is capable of, configured to, or operable to support a means for decoding the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

Additionally, or alternatively, the communications manager 1120 may support wireless communications at a UE in accordance with examples as disclosed herein. For example, the communications manager 1120 is capable of, configured to, or operable to support a means for transmitting, to a network entity, a control signal indicating a transition time for activation of a main radio of the UE, where the transition time is based on a capability of the UE. The communications manager 1120 is capable of, configured to, or operable to support a means for receiving a second control signal indicating one or more gap values associated with one or more WUS reception occasions for monitoring for one or more WUSs, the one or more WUS reception occasions associated with a paging signal reception occasion for monitoring for a paging signal. The communications manager 1120 is capable of, configured to, or operable to support a means for monitoring, during a sleep state using a wake-up radio of the UE, for a WUS of the one or more WUSs during a first WUS reception occasion of the one or more WUS reception occasions based on a first gap value of the one or more gap values. The communications manager 1120 is capable of, configured to, or operable to support a means for transitioning a main radio of the UE to an active state before the paging signal reception occasion based on reception of the WUS during the first WUS reception occasion and the indicated transition time.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced power consumption by enabling use of single branch demodulation as well as reduced power consumption and longer battery life by enabling a UE to remain in a sleep state longer.

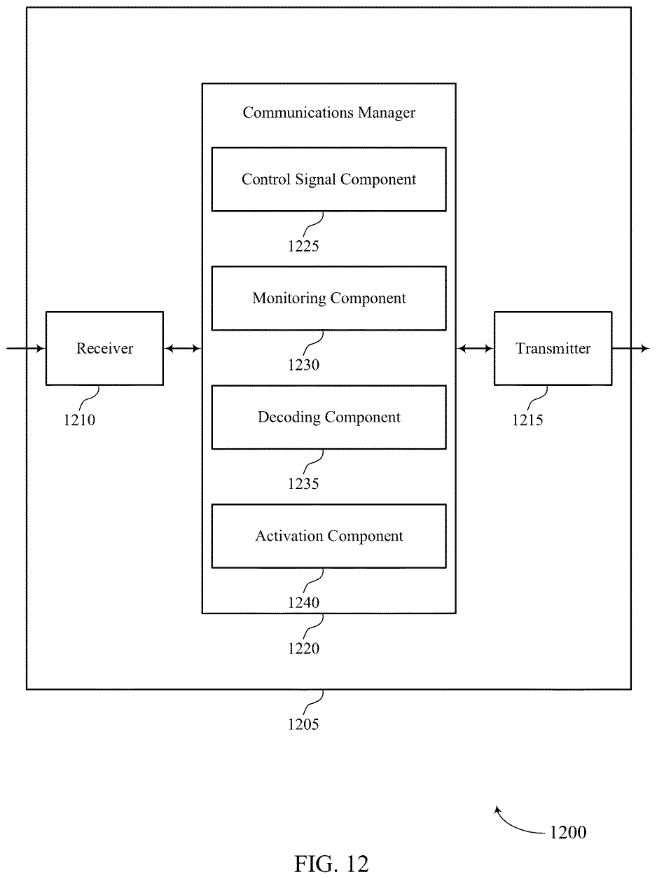

FIG. 12 shows a block diagram 1200 of a device 1205 that supports waveform generation for WUSs in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to waveform generation for WUSs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to waveform generation for WUSs). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of waveform generation for WUSs as described herein. For example, the communications manager 1220 may include a control signal component 1225, a monitoring component 1230, a decoding component 1235, an activation component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a UE in accordance with examples as disclosed herein. The control signal component 1225 is capable of, configured to, or operable to support a means for receiving a control signal indicating a waveform type for a WUS for the UE and indicating one or more parameters for the waveform type, where the one or more parameters indicate a base frequency for the WUS and a pair of frequency shift values associated with the WUS. The monitoring component 1230 is capable of, configured to, or operable to support a means for monitoring, using a wake-up radio of the UE, for the WUS of the waveform type based on the one or more parameters. The decoding component 1235 is capable of, configured to, or operable to support a means for decoding the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

Additionally, or alternatively, the communications manager 1220 may support wireless communications at a UE in accordance with examples as disclosed herein. The control signal component 1225 is capable of, configured to, or operable to support a means for transmitting, to a network entity, a control signal indicating a transition time for activation of a main radio of the UE, where the transition time is based on a capability of the UE. The control signal component 1225 is capable of, configured to, or operable to support a means for receiving a second control signal indicating one or more gap values associated with one or more WUS reception occasions for monitoring for one or more WUSs, the one or more WUS reception occasions associated with a paging signal reception occasion for monitoring for a paging signal. The monitoring component 1230 is capable of, configured to, or operable to support a means for monitoring, during a sleep state using a wake-up radio of the UE, for a WUS of the one or more WUSs during a first WUS reception occasion of the one or more WUS reception occasions based on a first gap value of the one or more gap values. The activation component 1240 is capable of, configured to, or operable to support a means for transitioning a main radio of the UE to an active state before the paging signal reception occasion based on reception of the WUS during the first WUS reception occasion and the indicated transition time.

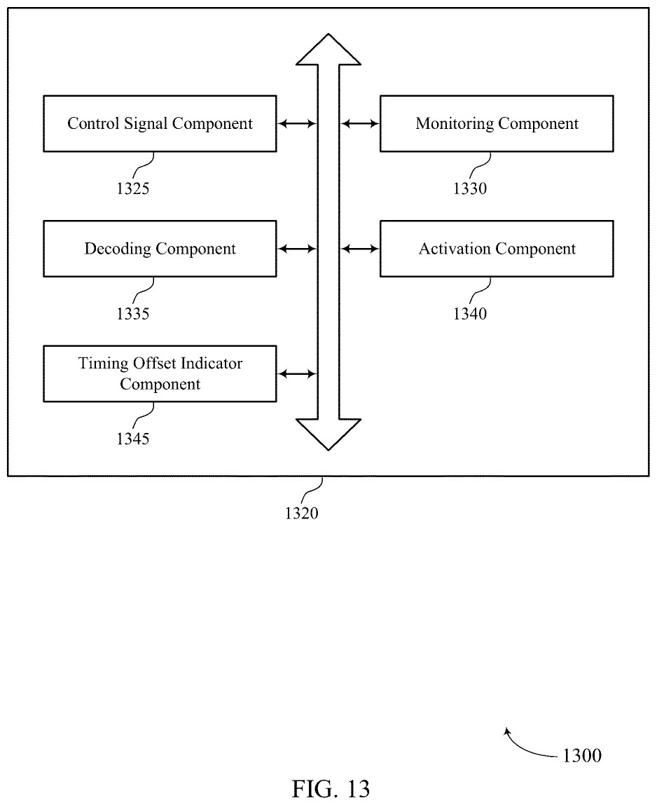

FIG. 13 shows a block diagram 1300 of a communications manager 1320 that supports waveform generation for WUSs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of waveform generation for WUSs as described herein. For example, the communications manager 1320 may include a control signal component 1325, a monitoring component 1330, a decoding component 1335, an activation component 1340, a timing offset indicator component 1345, or any combination thereof. Each of these components may communicate, directly or indirectly, with one another (e.g., via one or more buses).

The communications manager 1320 may support wireless communications at a UE in accordance with examples as disclosed herein. The control signal component 1325 is capable of, configured to, or operable to support a means for receiving a control signal indicating a waveform type for a WUS for the UE and indicating one or more parameters for the waveform type, where the one or more parameters indicate a base frequency for the WUS and a pair of frequency shift values associated with the WUS. The monitoring component 1330 is capable of, configured to, or operable to support a means for monitoring, using a wake-up radio of the UE, for the WUS of the waveform type based on the one or more parameters. The decoding component 1335 is capable of, configured to, or operable to support a means for decoding the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

In some examples, to support decoding the WUS, the decoding component 1335 is capable of, configured to, or operable to support a means for obtaining one or more bits associated with the second bit value based on a first frequency shift relative to the base frequency in accordance with a first frequency shift value of the pair of frequency values, and a second frequency shift relative to the base frequency in accordance with a second frequency shift value of the pair of frequency shift values, the second frequency shift value opposite to the first frequency shift value.

In some examples, to support decoding the WUS, the decoding component 1335 is capable of, configured to, or operable to support a means for obtaining one or more bits of the first bit value based on the first bit value being mapped to a first subcarrier of a first resource block in accordance with a first subcarrier index. In some examples, to support decoding the WUS, the decoding component 1335 is capable of, configured to, or operable to support a means for obtaining one or more bits of the second bit value based on the second bit value being mapped to a second subcarrier of the first resource block in accordance with a second subcarrier index and to a third subcarrier of the first resource block in accordance with a third subcarrier index.

In some examples, to support decoding the WUS, the decoding component 1335 is capable of, configured to, or operable to support a means for obtaining one or more bits of the first bit value based on the first bit value being mapped to a first subcarrier of a first resource block in accordance with a first subcarrier index. In some examples, to support decoding the WUS, the decoding component 1335 is capable of, configured to, or operable to support a means for obtaining one or more bits of the second bit value based on the second bit value being mapped to a second subcarrier of the first resource block in accordance with a second subcarrier index and to a third subcarrier of a second resource block in accordance with a third subcarrier index.

In some examples, to support monitoring for the WUS, the monitoring component 1330 is capable of, configured to, or operable to support a means for monitoring for the WUS during a WUS reception occasion of a set of WUS resources, where decoding the WUS is based on monitoring for the WUS during the WUS reception occasion.

In some examples, the monitoring component 1330 is capable of, configured to, or operable to support a means for monitoring for a set of multiple WUSs during a set of multiple WUS reception occasions based on the one or more parameters, the set of multiple WUSs including the WUS, where the one or more parameters indicate a periodicity for monitoring for the set of multiple WUSs during the set of multiple WUS reception occasions.

In some examples, the activation component 1340 is capable of, configured to, or operable to support a means for transitioning a main radio of the UE from a sleep state to an active state based on a successful decoding of the WUS and in accordance with a transition time for activation of the main radio.

In some examples, the sleep state is associated with a deactivation of one or more components associated with the main radio of the UE, of the wake-up radio, or both, and to support transitioning to the active state, the activation component 1340 is capable of, configured to, or operable to support a means for activating at least one component of the one or more components based on the transition time.

In some examples, the waveform type includes a frequency modulated waveform type. In some examples, an amplitude of the frequency modulated waveform type is based on the pair of frequency shift values.

In some examples, a size of the frequency shift is greater than a size of a bandwidth associated with the WUS. In some examples, the second bit value for obtaining the one or more bits is based on the size of the frequency shift.

In some examples, the frequency shift is based on an integer multiple of one or more of the pair of frequency shift values.

In some examples, the frequency shift is based on a power of two multiple of one or more of the pair of frequency shift values.

In some examples, the one or more parameters indicate a quantity of frequency shifts relative to the base frequency in accordance with the pair of frequency shift values, a total bandwidth for the WUS including the base frequency and the pair of frequency shift values, or both.

Additionally, or alternatively, the communications manager 1320 may support wireless communications at a UE in accordance with examples as disclosed herein. In some examples, the control signal component 1325 is capable of, configured to, or operable to support a means for transmitting, to a network entity, a control signal indicating a transition time for activation of a main radio of the UE, where the transition time is based on a capability of the UE. In some examples, the control signal component 1325 is capable of, configured to, or operable to support a means for receiving a second control signal indicating one or more gap values associated with one or more WUS reception occasions for monitoring for one or more WUSs, the one or more WUS reception occasions associated with a paging signal reception occasion for monitoring for a paging signal. In some examples, the monitoring component 1330 is capable of, configured to, or operable to support a means for monitoring, during a sleep state using a wake-up radio of the UE, for a WUS of the one or more WUSs during a first WUS reception occasion of the one or more WUS reception occasions based on a first gap value of the one or more gap values. The activation component 1340 is capable of, configured to, or operable to support a means for transitioning a main radio of the UE to an active state before the paging signal reception occasion based on reception of the WUS during the first WUS reception occasion and the indicated transition time.

In some examples, to support receiving the second control signal indicating the one or more gap values associated with the one or more WUS reception occasions, the control signal component 1325 is capable of, configured to, or operable to support a means for receiving the control signal indicating the first gap value associated with the first WUS reception occasion and a second gap value of the one or more gap values, the second gap value associated with a second WUS reception occasion of the one or more WUS reception occasions, where monitoring for the WUS during the first WUS reception occasion is based on the first gap value associated with the first WUS reception occasion being greater than the indicated transition time.

In some examples, the first gap value is less than or equal to the second gap value. In some examples, monitoring for the WUS during the first WUS reception occasion is based on the first gap value being less than or equal to the second gap value.

In some examples, the first gap value is greater than the second gap value. In some examples, monitoring for the WUS during the first WUS reception occasion is based on the first gap value being greater than the second gap value and the second gap value being less than or equal to the indicated transition time.

In some examples, the timing offset indicator component 1345 is capable of, configured to, or operable to support a means for receiving a timing offset indicator, where transitioning the main radio to the active state is based on receiving the timing offset indicator.

In some examples, to support transitioning the main radio to the active state, the activation component 1340 is capable of, configured to, or operable to support a means for transitioning the main radio to the active state following the first WUS reception occasion based on a first value of the timing offset indicator.

In some examples, to support transitioning the main radio to the active state, the activation component 1340 is capable of, configured to, or operable to support a means for transitioning the main radio to the active state after a time offset following the first WUS reception occasion based on a second value of the timing offset indicator and a difference between the transition time and the first gap value satisfying threshold.

In some examples, the timing offset indicator is received within the WUS.

In some examples, the sleep state is associated with a deactivation of one or more components associated with a main radio of the UE, of the wake-up radio, or both. In some examples, transitioning the main radio to the active state includes activating at least one component of the one or more components based on the transition time.

In some examples, the transition time includes a time duration for transitioning the main radio to the active state and turning on the at least one component and is based on a capability of the UE.

In some examples, the first gap value includes a time duration between the first WUS reception occasion and the paging signal reception occasion.

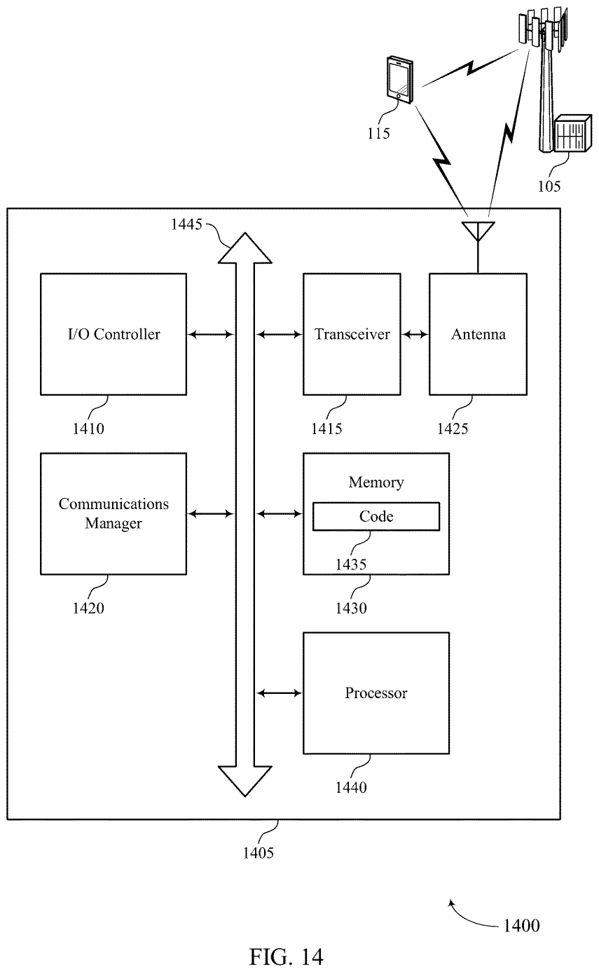

FIG. 14 shows a diagram of a system 1400 including a device 1405 that supports waveform generation for WUSs in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting waveform generation for WUSs). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communications at a UE in accordance with examples as disclosed herein. For example, the communications manager 1420 is capable of, configured to, or operable to support a means for receiving a control signal indicating a waveform type for a WUS for the UE and indicating one or more parameters for the waveform type, where the one or more parameters indicate a base frequency for the WUS and a pair of frequency shift values associated with the WUS. The communications manager 1420 is capable of, configured to, or operable to support a means for monitoring, using a wake-up radio of the UE, for the WUS of the waveform type based on the one or more parameters. The communications manager 1420 is capable of, configured to, or operable to support a means for decoding the WUS to obtain one or more bits of the WUS based on the monitoring, where a first bit value for obtaining the one or more bits is based on the base frequency and a second bit value for obtaining the one or more bits is based at least in part on a frequency shift relative to the base frequency in accordance with the pair of frequency shift values for the WUS.

Additionally, or alternatively, the communications manager 1420 may support wireless communications at a UE in accordance with examples as disclosed herein. For example, the communications manager 1420 is capable of, configured to, or operable to support a means for transmitting, to a network entity, a control signal indicating a transition time for activation of a main radio of the UE, where the transition time is based on a capability of the UE. The communications manager 1420 is capable of, configured to, or operable to support a means for receiving a second control signal indicating one or more gap values associated with one or more WUS reception occasions for monitoring for one or more WUSs, the one or more WUS reception occasions associated with a paging signal reception occasion for monitoring for a paging signal. The communications manager 1420 is capable of, configured to, or operable to support a means for monitoring, during a sleep state using a wake-up radio of the UE, for a WUS of the one or more WUSs during a first WUS reception occasion of the one or more WUS reception occasions based on a first gap value of the one or more gap values. The communications manager 1420 is capable of, configured to, or operable to support a means for transitioning a main radio of the UE to an active state before the paging signal reception occasion based on reception of the WUS during the first WUS reception occasion and the indicated transition time.

By including or configuring the communications manager 1420 in accordance with examples as described herein, the device 1405 may support techniques for reduced power consumption by enabling use of single branch demodulation as well as reduced power consumption and longer battery life by enabling a UE to remain in a sleep state longer.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of waveform generation for WUSs as described herein, or the processor 1440 and the memory 1430 may be otherwise configured to perform or support such operations.

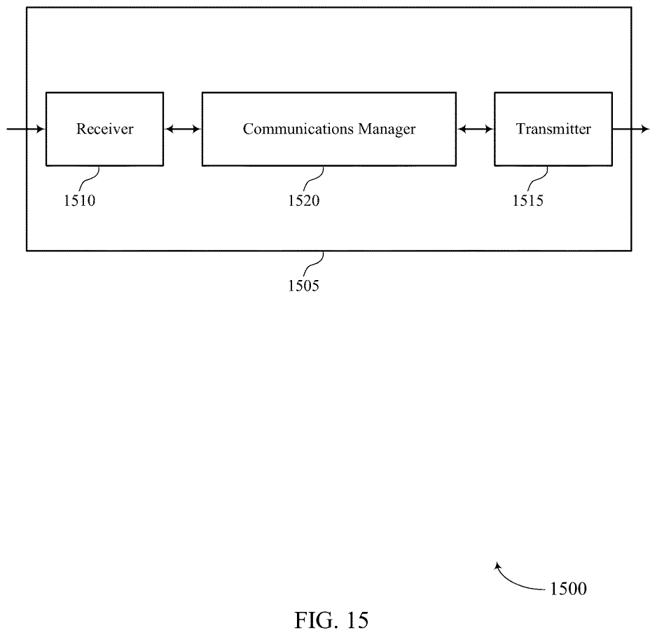

FIG. 15 shows a block diagram 1500 of a device 1505 that supports waveform generation for WUSs in accordance with one or more aspects of the present disclosure. The device 1505 may be an example of aspects of a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations thereof or various components thereof may be examples of means for performing various aspects of waveform generation for WUSs as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software) executed by a processor. If implemented in code executed by a processor, the functions of the communications manager 1520, the receiver 1510, the transmitter 1515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a network entity in accordance with examples as disclosed herein. For example, the communications manager 1520 is capable of, configured to, or operable to support a means for transmitting a control signal indicating a waveform type for a WUS for a UE and indicating one or more parameters for the WUS, where the one or more parameters indicate a base frequency for the WUS and a pair of frequency shift values associated with the WUS. The communications manager 1520 is capable of, configured to, or operable to support a means for generating the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS. The communications manager 1520 is capable of, configured to, or operable to support a means for transmitting the WUS of the waveform type based on the generating.

Additionally, or alternatively, the communications manager 1520 may support wireless communications at a network entity in accordance with examples as disclosed herein. For example, the communications manager 1520 is capable of, configured to, or operable to support a means for receiving a control signal indicating a transition time for activation of a main radio of a UE, where the transition time is based on a capability of the UE. The communications manager 1520 is capable of, configured to, or operable to support a means for transmitting a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time. The communications manager 1520 is capable of, configured to, or operable to support a means for transmitting, during a sleep state of the UE, a WUS during the first WUS reception occasion based on a first gap value of the one or more gap values, the first gap value associated with the first WUS reception occasion.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for more efficient utilization of communication resources and improved coordination between devices by supporting indication of a capability of a UE including supported transition times, as well as reduced power consumption at UEs by enabling use of single branch demodulation and by enabling a UE to remain in a sleep state longer.

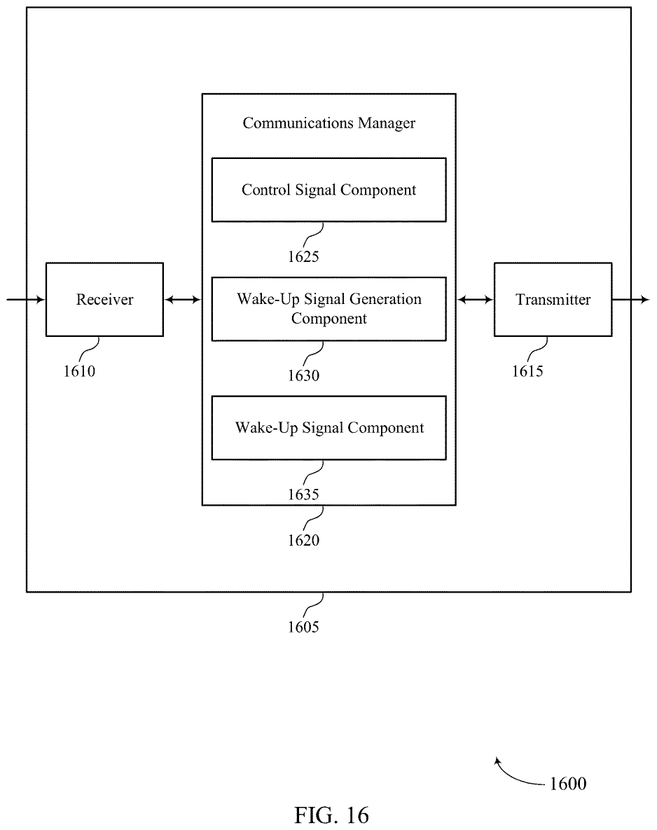

FIG. 16 shows a block diagram 1600 of a device 1605 that supports waveform generation for WUSs in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of waveform generation for WUSs as described herein. For example, the communications manager 1620 may include a control signal component 1625, a WUS generation component 1630, a WUS component 1635, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications at a network entity in accordance with examples as disclosed herein. The control signal component 1625 is capable of, configured to, or operable to support a means for transmitting a control signal indicating a waveform type for a WUS for a UE and indicating one or more parameters for the WUS, where the one or more parameters indicate a base frequency for the WUS and a pair of frequency shift values associated with the WUS. The WUS generation component 1630 is capable of, configured to, or operable to support a means for generating the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS. The WUS component 1635 is capable of, configured to, or operable to support a means for transmitting the WUS of the waveform type based on the generating.

Additionally, or alternatively, the communications manager 1620 may support wireless communications at a network entity in accordance with examples as disclosed herein. The control signal component 1625 is capable of, configured to, or operable to support a means for receiving a control signal indicating a transition time for activation of a main radio of a UE, where the transition time is based on a capability of the UE. The control signal component 1625 is capable of, configured to, or operable to support a means for transmitting a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time. The WUS component 1635 is capable of, configured to, or operable to support a means for transmitting, during a sleep state of the UE, a WUS during the first WUS reception occasion based on a first gap value of the one or more gap values, the first gap value associated with the first WUS reception occasion.

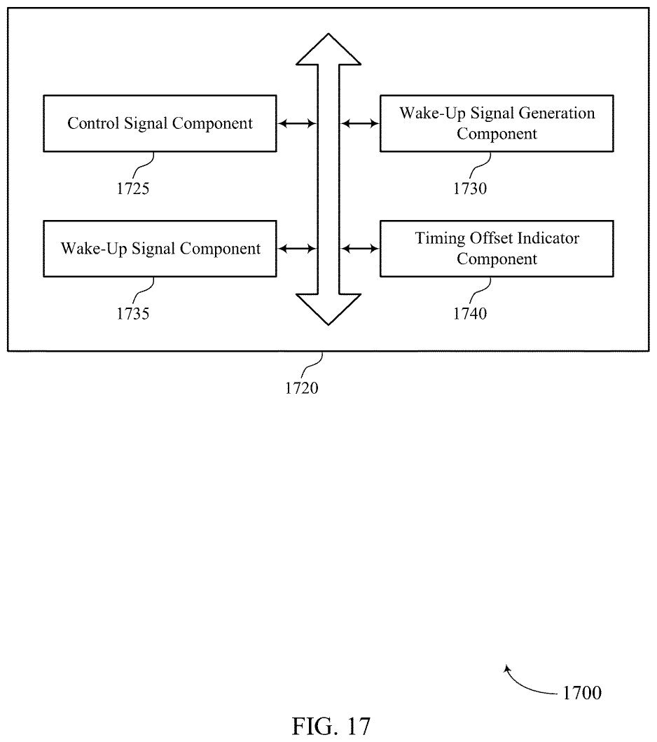

FIG. 17 shows a block diagram 1700 of a communications manager 1720 that supports waveform generation for WUSs in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of waveform generation for WUSs as described herein. For example, the communications manager 1720 may include a control signal component 1725, a WUS generation component 1730, a WUS component 1735, a timing offset indicator component 1740, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communications at a network entity in accordance with examples as disclosed herein. The control signal component 1725 is capable of, configured to, or operable to support a means for transmitting a control signal indicating a waveform type for a WUS for a UE and indicating one or more parameters for the WUS, where the one or more parameters indicate a base frequency for the WUS and a pair of frequency shift values associated with the WUS. The WUS generation component 1730 is capable of, configured to, or operable to support a means for generating the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS. The WUS component 1735 is capable of, configured to, or operable to support a means for transmitting the WUS of the waveform type based on the generating.

In some examples, the second bit value is based on a first frequency shift relative to the base frequency in accordance with a first frequency shift value of the pair of the pair of frequency values, and a second frequency shift relative to the base frequency in accordance with a second frequency shift value of the pair of frequency shift values, the second frequency shift value opposite to the first frequency shift value.

In some examples, the first bit value for obtaining the one or more bits is mapped to a first subcarrier of a first resource block based on a first subcarrier index and the second bit value for obtaining the one or more bits is mapped to a second subcarrier of the first resource block based on a second subcarrier index and to a third subcarrier of the first resource block in accordance with a third subcarrier index.

In some examples, the first bit value for obtaining the one or more bits is mapped to a first subcarrier of a first resource block based on a first subcarrier index and the second bit value for obtaining the one or more bits is mapped to a second subcarrier of the first resource block based on a second subcarrier index and to a third subcarrier of a second resource block based on a third subcarrier index.

In some examples, to support transmitting the WUS, the WUS component 1735 is capable of, configured to, or operable to support a means for transmitting the WUS during a WUS reception occasion of a set of WUS resources.

In some examples, the WUS component 1735 is capable of, configured to, or operable to support a means for transmitting a set of multiple WUSs during a set of multiple WUS reception occasions based on transmitting the control signal and generating the set of multiple WUSs, the set of multiple WUSs including the WUS, where the one or more parameters indicate a periodicity for monitoring for the set of multiple WUSs during the set of multiple WUS reception occasions.

In some examples, the WUS is associated with a transition of a main radio of the UE from a sleep state to an active state based on a successful decoding of the WUS and a transition time for activation of the main radio.

In some examples, the sleep state is associated with a deactivation of one or more components associated with the main radio of the UE, of a wake-up radio of the UE, or both. In some examples, the transition of the main radio to the active state is associated with an activation of at least one component of the one or more components based on the transition time.

In some examples, the waveform type includes a frequency modulated waveform type. In some examples, an amplitude of the frequency modulated waveform type is based on the pair of frequency shift values.

In some examples, a size of the frequency shift is greater than a size of a bandwidth associated with the WUS. In some examples, the second bit value for obtaining the one or more bits is based on the size of the frequency shift.

In some examples, the frequency shift is based on an integer multiple of one or more of the pair of frequency shift values.

In some examples, the frequency shift is based on a power of two multiple of one or more of the pair of frequency shift values.

In some examples, the one or more parameters further indicate a quantity of frequency shifts relative to the base frequency in accordance with the pair of frequency shift values, a total bandwidth for the WUS including the base frequency and the pair of frequency shift values, or both.

Additionally, or alternatively, the communications manager 1720 may support wireless communications at a network entity in accordance with examples as disclosed herein. In some examples, the control signal component 1725 is capable of, configured to, or operable to support a means for receiving a control signal indicating a transition time for activation of a main radio of a UE, where the transition time is based on a capability of the UE. In some examples, the control signal component 1725 is capable of, configured to, or operable to support a means for transmitting a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time. In some examples, the WUS component 1735 is capable of, configured to, or operable to support a means for transmitting, during a sleep state of the UE, a WUS during the first WUS reception occasion based on a first gap value of the one or more gap values, the first gap value associated with the first WUS reception occasion.

In some examples, to support transmitting the second control signal indicating the one or more gap values associated with the one or more WUS reception occasions, the control signal component 1725 is capable of, configured to, or operable to support a means for transmitting the second control signal indicating the first gap value associated with the first WUS reception occasion and a second gap value of the one or more gap values, the second gap value associated with a second WUS reception occasion of the one or more WUS reception occasions, where transmitting the WUS during the first WUS reception occasion is based on the first gap value associated with the first WUS reception occasion being greater than the indicated transition time.

In some examples, the first gap value is less than or equal to the second gap value. In some examples, transmitting the WUS during the first WUS reception occasion is based on the first gap value being less than or equal to the second gap value.

In some examples, the first gap value is greater than the second gap value. In some examples, transmitting the WUS during the first WUS reception occasion is based on the first gap value being greater than the second gap value and the second gap value being less than or equal to the indicated transition time.

In some examples, the timing offset indicator component 1740 is capable of, configured to, or operable to support a means for transmitting a timing offset indicator indicating a first value or a second value, where transmitting the WUS during the first WUS reception occasion is based on transmitting the timing offset indicator.

In some examples, the first value of the timing offset indicator is associated with the active state. In some examples, the second value of the timing offset indicator is associated with a time offset, the active state, and a difference between the transition time and the first gap value satisfying a threshold.

In some examples, the timing offset indicator is transmitted within the WUS.

In some examples, the sleep state is associated with a deactivation of one or more components associated with a main radio of the UE, of a wake-up radio of the UE, or both. In some examples, a transition of the main radio to the active state includes an activation of at least one component of the one or more components based on the transition time.

In some examples, the transition time includes a time duration for the transition of the main radio to the active state and for the at least one component to turn on, and is based on a capability of the UE.

In Some Examples, the First Gap Value Includes a Time Duration Between the First WUS Reception Occasion and the Paging Signal Reception Occasion.

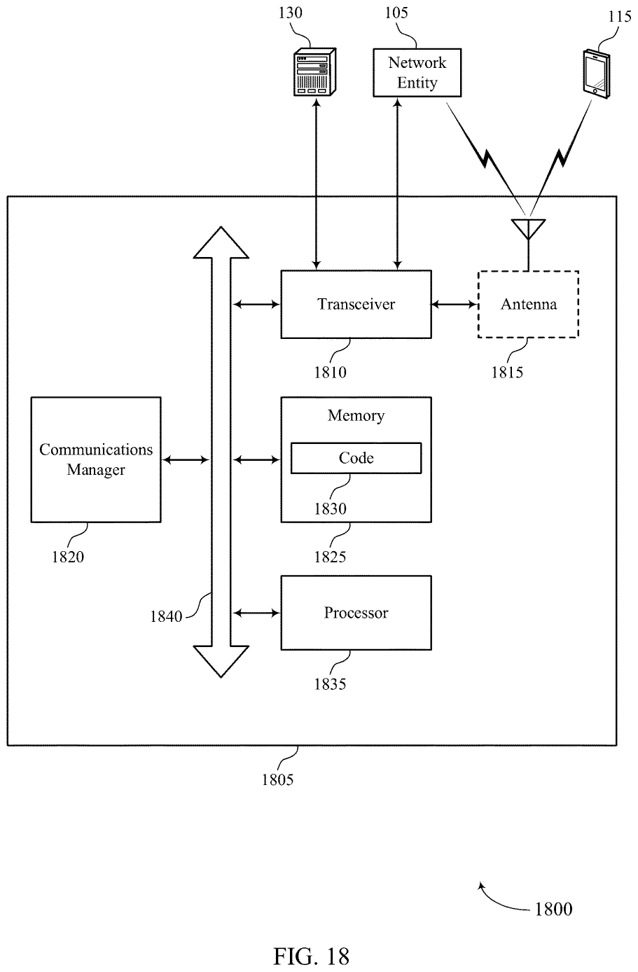

FIG. 18 shows a diagram of a system 1800 including a device 1805 that supports waveform generation for WUSs in accordance with one or more aspects of the present disclosure. The device 1805 may be an example of or include the components of a device 1505, a device 1605, or a network entity 105 as described herein. The device 1805 may communicate with one or more network entities 105, one or more UEs 115, or any combination thereof, which may include communications over one or more wired interfaces, over one or more wireless interfaces, or any combination thereof. The device 1805 may include components that support outputting and obtaining communications, such as a communications manager 1820, a transceiver 1810, an antenna 1815, a memory 1825, code 1830, and a processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or memory components (for example, the processor 1835, or the memory 1825, or both), may be included in a chip or chip assembly that is installed in the device 1805. In some examples, the transceiver may be operable to support communications via one or more communications links (e.g., a communication link 125, a backhaul communication link 120, a midhaul communication link 162, a fronthaul communication link 168).

The memory 1825 may include RAM and ROM. The memory 1825 may store computer-readable, computer-executable code 1830 including instructions that, when executed by the processor 1835, cause the device 1805 to perform various functions described herein. The code 1830 may be stored in a non-transitory computer-readable medium such as system memory or another type of memory. In some cases, the code 1830 may not be directly executable by the processor 1835 but may cause a computer (e.g., when compiled and executed) to perform functions described herein. In some cases, the memory 1825 may contain, among other things, a BIOS which may control basic hardware or software operation such as the interaction with peripheral components or devices.

The processor 1835 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1835 may be configured to operate a memory array using a memory controller. In some other cases, a memory controller may be integrated into the processor 1835. The processor 1835 may be configured to execute computer-readable instructions stored in a memory (e.g., the memory 1825) to cause the device 1805 to perform various functions (e.g., functions or tasks supporting waveform generation for WUSs). For example, the device 1805 or a component of the device 1805 may include a processor 1835 and memory 1825 coupled with the processor 1835, the processor 1835 and memory 1825 configured to perform various functions described herein. The processor 1835 may be an example of a cloud-computing platform (e.g., one or more physical nodes and supporting software such as operating systems, virtual machines, or container instances) that may host the functions (e.g., by executing code 1830) to perform the functions of the device 1805. The processor 1835 may be any one or more suitable processors capable of executing scripts or instructions of one or more software programs stored in the device 1805 (such as within the memory 1825). In some implementations, the processor 1835 may be a component of a processing system. A processing system may generally refer to a system or series of machines or components that receives inputs and processes the inputs to produce a set of outputs (which may be passed to other systems or components of, for example, the device 1805). For example, a processing system of the device 1805 may refer to a system including the various other components or subcomponents of the device 1805, such as the processor 1835, or the transceiver 1810, or the communications manager 1820, or other components or combinations of components of the device 1805. The processing system of the device 1805 may interface with other components of the device 1805, and may process information received from other components (such as inputs or signals) or output information to other components. For example, a chip or modem of the device 1805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1805 may transmit information output from the chip or modem. Additionally, or alternatively, in some implementations, the one or more interfaces may refer to an interface between the processing system of the chip or modem and a receiver, such that the device 1805 may obtain information or signal inputs, and the information may be passed to the processing system. A person having ordinary skill in the art will readily recognize that a first interface also may obtain information or signal inputs, and a second interface also may output information or signal outputs.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the memory 1825, the code 1830, and the processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with other network entities 105, and may include a controller or scheduler for controlling communications with UEs 115 in cooperation with other network entities 105. In some examples, the communications manager 1820 may support an X2 interface within an LTE/LTE-A wireless communications network technology to provide communication between network entities 105.

The communications manager 1820 may support wireless communications at a network entity in accordance with examples as disclosed herein. For example, the communications manager 1820 is capable of, configured to, or operable to support a means for transmitting a control signal indicating a waveform type for a WUS for a UE and indicating one or more parameters for the WUS, where the one or more parameters indicate a base frequency for the WUS and a pair of frequency shift values associated with the WUS. The communications manager 1820 is capable of, configured to, or operable to support a means for generating the WUS of the waveform type based on transmitting the control signal and encoding one or more bits of the WUS, where a first bit value for encoding the one or more bits is based on the base frequency and a second bit value for encoding the one or more bits is based on a frequency shift relative to the base frequency in accordance with the pair of frequency shift values for the WUS. The communications manager 1820 is capable of, configured to, or operable to support a means for transmitting the WUS of the waveform type based on the generating.

Additionally, or alternatively, the communications manager 1820 may support wireless communications at a network entity in accordance with examples as disclosed herein. For example, the communications manager 1820 is capable of, configured to, or operable to support a means for receiving a control signal indicating a transition time for activation of a main radio of a UE, where the transition time is based on a capability of the UE. The communications manager 1820 is capable of, configured to, or operable to support a means for transmitting a second control signal indicating one or more gap values associated with one or more WUS reception occasions for monitoring for one or more WUSs, the one or more WUS reception occasions associated with paging signal reception occasion for monitoring for a paging signal, where a first WUS reception occasion of the one or more WUS reception occasions is associated with an active state and the indicated transition time. The communications manager 1820 is capable of, configured to, or operable to support a means for transmitting, during a sleep state of the UE, a WUS during the first WUS reception occasion based on a first gap value of the one or more gap values, the first gap value associated with the first WUS reception occasion.

By including or configuring the communications manager 1820 in accordance with examples as described herein, the device 1805 may support techniques for more efficient utilization of communication resources and improved coordination between devices by supporting indication of a capability of a UE including supported transition times, as well as reduced power consumption at UEs by enabling use of single branch demodulation and by enabling a UE to remain in a sleep state longer.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, the processor 1835, the memory 1825, the code 1830, or any combination thereof. For example, the code 1830 may include instructions executable by the processor 1835 to cause the device 1805 to perform various aspects of waveform generation for WUSs as described herein, or the processor 1835 and the memory 1825 may be otherwise configured to perform or support such operations.

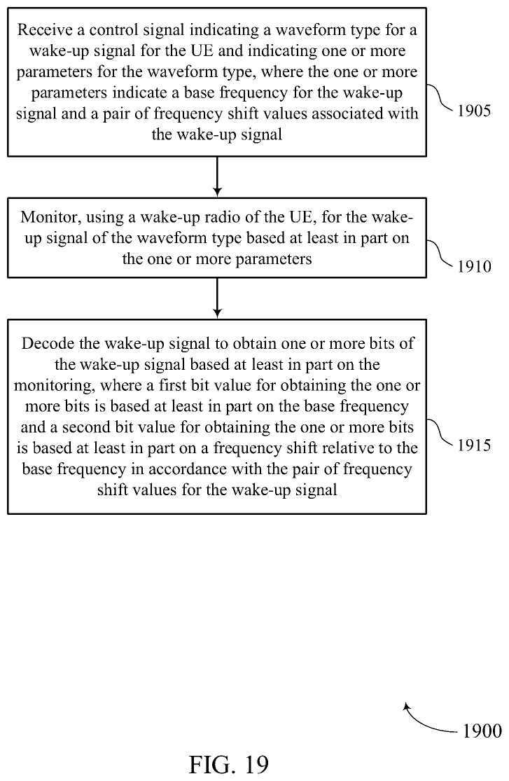

FIG. 19 shows a flowchart illustrating a method 1900 that supports waveform generation for WUSs in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the wireless UE to perform the described functions. Additionally, or alternatively, the wireless UE may perform aspects of the described functions using special-purpose hardware.

At 1905, the method may include receiving a control signal indicating a waveform type for a wake-up signal for the UE and indicating one or more parameters for the waveform type, where the one or more parameters indicate a base frequency for the wake-up signal and a pair of frequency shift values associated with the wake-up signal. The operations of 1905 may be performed in accordance with examples as disclosed herein. In some examples, aspects of the operations of 1905 may be performed by a control signal component 1325 as described with reference to FIG. 13.

At 1910, the method may include monitoring, using a wake-up radio of the UE, for the wake-up signal of the waveform type based at least in part on the one or more parameters. The operations of 1910 may be performed in accordance with examples as disclosed herein. In some examples, aspects of the operations of 1910 may be performed by a monitoring component 1330 as described with reference to FIG. 13.

At 1915, the method may include decoding the wake-up signal to obtain one or more bits of the wake-up signal based at least in part on the monitoring, where a first bit value for obtaining the one or more bits is based at least in part on the base frequency and a second bit value for obtaining the one or more bits is based at least in part on a frequency shift relative to the base frequency in accordance with the pair of frequency shift values for the wake-up signal. The operations of 1915 may be performed in accordance with examples as disclosed herein. In some examples, aspects of the operations of 1915 may be performed by a decoding component 1335 as described with reference to FIG. 13.

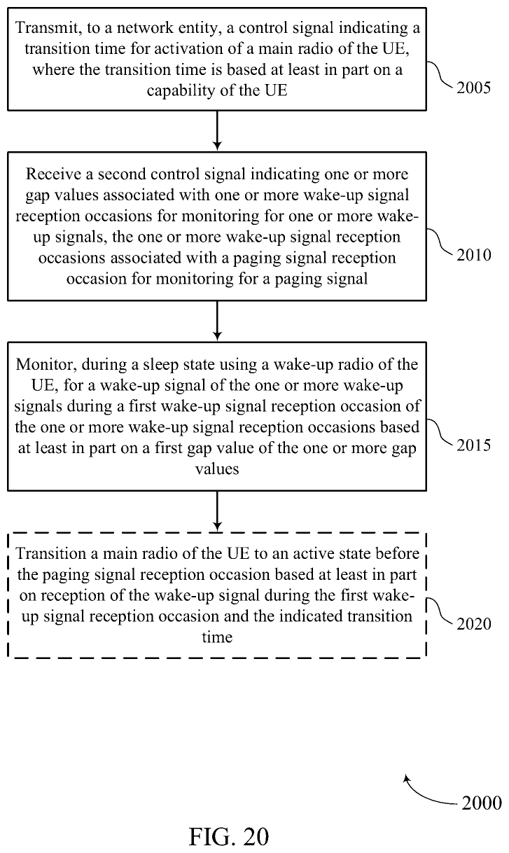

FIG. 20 shows a flowchart illustrating a method 2000 that supports waveform generation for WUSs in accordance with aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the wireless UE to perform the described functions. Additionally, or alternatively, the wireless UE may perform aspects of the described functions using special-purpose hardware.

At 2005, the method may include transmitting, to a network entity, a control signal indicating a transition time for activation of a main radio of the UE, where the transition time is based at least in part on a capability of the UE. The operations of 2005 may be performed in accordance with examples as disclosed herein. In some examples, aspects of the operations of 2005 may be performed by a control signal component 1325 as described with reference to FIG. 13.

At 2010, the method may include receiving a second control signal indicating one or more gap values associated with one or more wake-up signal reception occasions for monitoring for one or more wake-up signals, the one or more wake-up signal reception occasions associated with a paging signal reception occasion for monitoring for a paging signal. The operations of 2010 may be performed in accordance with examples as disclosed herein. In some examples, aspects of the operations of 2010 may be performed by a control signal component 1325 as described with reference to FIG. 13.

At 2015, the method may include monitoring, during a sleep state using a wake-up radio of the UE, for a wake-up signal of the one or more wake-up signals during a first wake-up signal reception occasion of the one or more wake-up signal reception occasions based at least in part on a first gap value of the one or more gap values. The operations of 2015 may be performed in accordance with examples as disclosed herein. In some examples, aspects of the operations of 2015 may be performed by a monitoring component 1330 as described with reference to FIG. 13.

At 2020, the method may optionally include transitioning a main radio of the UE to an active state before the paging signal reception occasion based at least in part on reception of the wake-up signal during the first wake-up signal reception occasion and the indicated transition time. The operations of 2020 may be performed in accordance with examples as disclosed herein. In some examples, aspects of the operations of 2020 may be performed by an activation component 1340 as described with reference to FIG. 13.

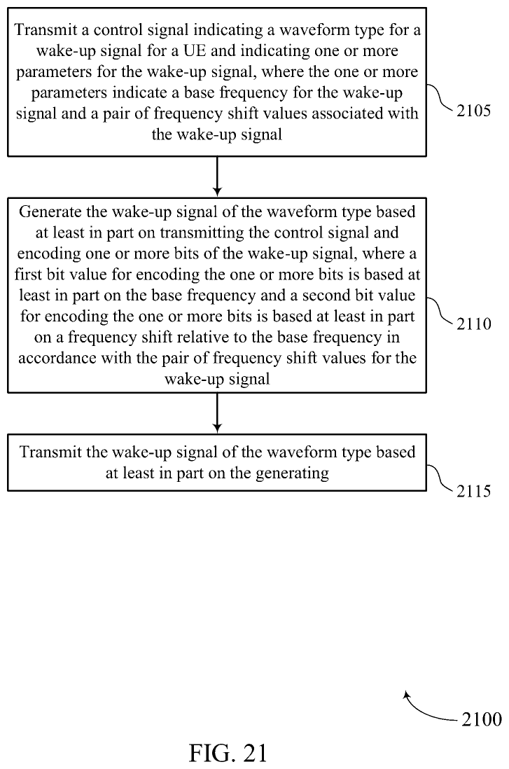

FIG. 21 shows a flowchart illustrating a method 2100 that supports waveform generation for WUSs in accordance with aspects of the present disclosure. The operations of the method 2100 may be implemented by a network entity or its components as described herein. For example, the operations of the method 2100 may be performed by a network entity as described with reference to FIGS. 1 through 10 and 15 through 18. In some examples, a network entity may execute a set of instructions to control the functional elements of the wireless network entity to perform the described functions. Additionally, or alternatively, the wireless network entity may perform aspects of the described functions using special-purpose hardware.

At 2105, the method may include transmitting a control signal indicating a waveform type for a wake-up signal for a UE and indicating one or more parameters for the wake-up signal, where the one or more parameters indicate a base frequency for the wake-up signal and a pair of frequency shift values associated with the wake-up signal. The operations of 2105 may be performed in accordance with examples as disclosed herein. In some examples, aspects of the operations of 2105 may be performed by a control signal component 1725 as described with reference to FIG. 17.

At 2110, the method may include generating the wake-up signal of the waveform type based at least in part on transmitting the control signal and encoding one or more bits of the wake-up signal, where a first bit value for encoding the one or more bits is based at least in part on the base frequency and a second bit value for encoding the one or more bits is based at least in part on a frequency shift relative to the base frequency in accordance with the pair of frequency shift values for the wake-up signal.

The operations of 2110 may be performed in accordance with examples as disclosed herein. In some examples, aspects of the operations of 2110 may be performed by a wake-up signal generation component 1730 as described with reference to FIG. 17.

At 2115, the method may include transmitting the wake-up signal of the waveform type based at least in part on the generating. The operations of 2115 may be performed in accordance with examples as disclosed herein. In some examples, aspects of the operations of 2115 may be performed by a wake-up signal component 1735 as described with reference to FIG. 17.

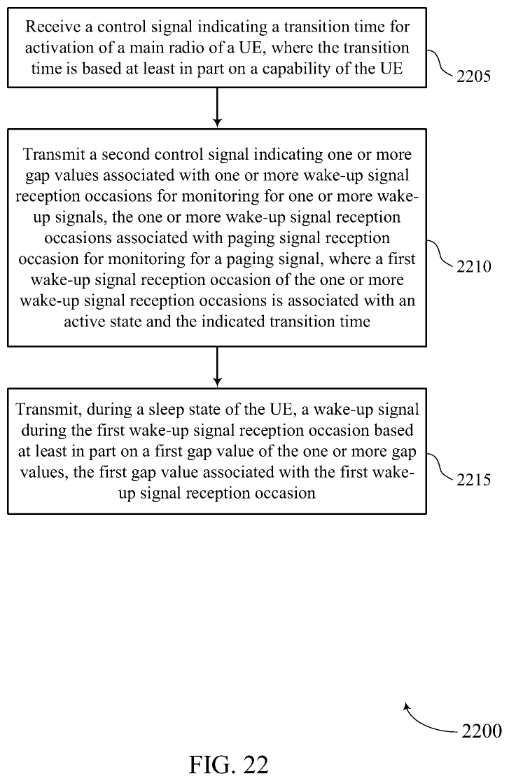

FIG. 22 shows a flowchart illustrating a method 2200 that supports waveform generation for WUSs in accordance with aspects of the present disclosure. The operations of the method 2200 may be implemented by a network entity or its components as described herein. For example, the operations of the method 2200 may be performed by a network entity as described with reference to FIGS. 1 through 10 and 15 through 18. In some examples, a network entity may execute a set of instructions to control the functional elements of the wireless network entity to perform the described functions. Additionally, or alternatively, the wireless network entity may perform aspects of the described functions using special-purpose hardware.

At 2205, the method may include receiving a control signal indicating a transition time for activation of a main radio of a UE, where the transition time is based at least in part on a capability of the UE. The operations of 2205 may be performed in accordance with examples as disclosed herein. In some examples, aspects of the operations of 2205 may be performed by a control signal component 1725 as described with reference to FIG. 17.

At 2210, the method may include transmitting a second control signal indicating one or more gap values associated with one or more wake-up signal reception occasions for monitoring for one or more wake-up signals, the one or more wake-up signal reception occasions associated with paging signal reception occasion for monitoring for a paging signal, where a first wake-up signal reception occasion of the one or more wake-up signal reception occasions is associated with an active state and the indicated transition time. The operations of 2210 may be performed in accordance with examples as disclosed herein. In some examples, aspects of the operations of 2210 may be performed by a control signal component 1725 as described with reference to FIG. 17.

At 2215, the method may include transmitting, during a sleep state of the UE, a wake-up signal during the first wake-up signal reception occasion based at least in part on a first gap value of the one or more gap values, the first gap value associated with the first wake-up signal reception occasion. The operations of 2215 may be performed in accordance with examples as disclosed herein. In some examples, aspects of the operations of 2215 may be performed by a wake-up signal component 1735 as described with reference to FIG. 17.

The Following Provides an Overview of Aspects of the Present Disclosure:

Aspect 1: A method for wireless communications at a UE, comprising: receiving a control signal indicating a waveform type for a wake-up signal for the UE and indicating one or more parameters for the waveform type, wherein the one or more parameters indicate a base frequency for the wake-up signal and a pair of frequency shift values associated with the wake-up signal; monitoring, using a wake-up radio of the UE, for the wake-up signal of the waveform type based at least in part on the one or more parameters; and decoding the wake-up signal to obtain one or more bits of the wake-up signal based at least in part on the monitoring, wherein a first bit value for obtaining the one or more bits is based at least in part on the base frequency and a second bit value for obtaining the one or more bits is based at least in part on a frequency shift relative to the base frequency in accordance with the pair of frequency shift values for the wake-up signal.

Aspect 2: The method of aspect 1, wherein decoding the wake-up signal comprises: obtaining one or more bits associated with the second bit value based at least in part on a first frequency shift relative to the base frequency in accordance with a first frequency shift value of the pair of frequency values, and a second frequency shift relative to the base frequency in accordance with a second frequency shift value of the pair of frequency shift values, the second frequency shift value opposite to the first frequency shift value.

Aspect 3: The method of any of aspects 1 through 2, wherein decoding the wake-up signal comprises: obtaining one or more bits of the first bit value based at least in part on the first bit value being mapped to a first subcarrier of a first resource block in accordance with a first subcarrier index; and obtaining one or more bits of the second bit value based at least in part on the second bit value being mapped to a second subcarrier of the first resource block in accordance with a second subcarrier index and to a third subcarrier of the first resource block in accordance with a third subcarrier index.

Aspect 4: The method of any of aspects 1 through 2, wherein decoding the wake-up signal comprises: obtaining one or more bits of the first bit value based at least in part on the first bit value being mapped to a first subcarrier of a first resource block in accordance with a first subcarrier index; and obtaining one or more bits of the second bit value based at least in part on the second bit value being mapped to a second subcarrier of the first resource block in accordance with a second subcarrier index and to a third subcarrier of a second resource block in accordance with a third subcarrier index.

Aspect 5: The method of any of aspects 1 through 4, wherein monitoring for the wake-up signal comprises: monitoring for the wake-up signal during a wake-up signal reception occasion of a set of wake-up signal resources, wherein decoding the wake-up signal is based at least in part on monitoring for the wake-up signal during the wake-up signal reception occasion.

Aspect 6: The method of aspect 5, further comprising: monitoring for a plurality of wake-up signals during a plurality of wake-up signal reception occasions based at least in part on the one or more parameters, the plurality of wake-up signals comprising the wake-up signal, wherein the one or more parameters indicate a periodicity for monitoring for the plurality of wake-up signals during the plurality of wake-up signal reception occasions.

Aspect 7: The method of any of aspects 1 through 6, further comprising: transitioning a main radio of the UE from a sleep state to an active state based at least in part on a successful decoding of the wake-up signal and in accordance with a transition time for activation of the main radio.

Aspect 8: The method of aspect 7, wherein the sleep state is associated with a deactivation of one or more components associated with the main radio of the UE, of the wake-up radio, or both, wherein transitioning to the active state comprises: activating at least one component of the one or more components based at least in part on the transition time.

Aspect 9: The method of any of aspects 1 through 8, wherein the waveform type comprises a frequency modulated waveform type, wherein an amplitude of the frequency modulated waveform type is based at least in part on the pair of frequency shift values.

Aspect 10: The method of any of aspects 1 through 9, wherein a size of the frequency shift is greater than a size of a bandwidth associated with the wake-up signal, wherein the second bit value for obtaining the one or more bits is based at least in part on the size of the frequency shift.

Aspect 11: The method of any of aspects 1 through 10, wherein the frequency shift is based at least in part on an integer multiple of one or more of the pair of frequency shift values.

Aspect 12: The method of any of aspects 1 through 10, wherein the frequency shift is based at least in part on a power of two multiple of one or more of the pair of frequency shift values.

Aspect 13: The method of any of aspects 1 through 12, wherein the one or more parameters indicate a quantity of frequency shifts relative to the base frequency in accordance with the pair of frequency shift values, a total bandwidth for the wake-up signal comprising the base frequency and the pair of frequency shift values, or both.

Aspect 14: A method for wireless communications at a UE, comprising: transmitting, to a network entity, a control signal indicating a transition time for activation of a main radio of the UE, wherein the transition time is based at least in part on a capability of the UE; receiving a second control signal indicating one or more gap values associated with one or more wake-up signal reception occasions for monitoring for one or more wake-up signals, the one or more wake-up signal reception occasions associated with a paging signal reception occasion for monitoring for a paging signal;
monitoring, during a sleep state using a wake-up radio of the UE, for a wake-up signal of the one or more wake-up signals during a first wake-up signal reception occasion of the one or more wake-up signal reception occasions based at least in part on a first gap value of the one or more gap values; and transitioning a main radio of the UE to an active state before the paging signal reception occasion based at least in part on reception of the wake-up signal during the first wake-up signal reception occasion and the indicated transition time.

Aspect 15: The method of aspect 14, wherein receiving the second control signal indicating the one or more gap values associated with the one or more wake-up signal reception occasions comprises: receiving the control signal indicating the first gap value associated with the first wake-up signal reception occasion and a second gap value of the one or more gap values, the second gap value associated with a second wake-up signal reception occasion of the one or more wake-up signal reception occasions, wherein monitoring for the wake-up signal during the first wake-up signal reception occasion is based at least in part on the first gap value associated with the first wake-up signal reception occasion being greater than the indicated transition time.

Aspect 16: The method of aspect 15, wherein the first gap value is less than or equal to the second gap value, wherein monitoring for the wake-up signal during the first wake-up signal reception occasion is based at least in part on the first gap value being less than or equal to the second gap value.

Aspect 17: The method of aspect 15, wherein the first gap value is greater than the second gap value, wherein monitoring for the wake-up signal during the first wake-up signal reception occasion is based at least in part on the first gap value being greater than the second gap value and the second gap value being less than or equal to the indicated transition time.

Aspect 18: The method of any of aspects 14 through 17, further comprising: receiving a timing offset indicator, wherein transitioning the main radio to the active state is based at least in part on receiving the timing offset indicator.

Aspect 19: The method of aspect 18, wherein transitioning the main radio to the active state comprises: transitioning the main radio to the active state following the first wake-up signal reception occasion based at least in part on a first value of the timing offset indicator.

Aspect 20: The method of aspect 18, wherein transitioning the main radio to the active state comprises: transitioning the main radio to the active state after a time offset following the first wake-up signal reception occasion based at least in part on a second value of the timing offset indicator and a difference between the transition time and the first gap value satisfying a threshold.

Aspect 21: The method of any of aspects 18 through 20, wherein the timing offset indicator is received within the wake-up signal.

Aspect 22: The method of any of aspects 14 through 21, wherein the sleep state is associated with a deactivation of one or more components associated with a main radio of the UE, of the wake-up radio, or both, and wherein transitioning the main radio to the active state comprises activating at least one component of the one or more components based at least in part on the transition time.

Aspect 23: The method of aspect 22, wherein the transition time comprises a time duration for transitioning the main radio to the active state and turning on the at least one component and is based at least in part on a capability of the UE.

Aspect 24: The method of any of aspects 14 through 23, wherein the first gap value comprises a time duration between the first wake-up signal reception occasion and the paging signal reception occasion.

Aspect 25: A method for wireless communications at a network entity, comprising: transmitting a control signal indicating a waveform type for a wake-up signal for a UE and indicating one or more parameters for the wake-up signal, wherein the one or more parameters indicate a base frequency for the wake-up signal and a pair of frequency shift values associated with the wake-up signal; generating the wake-up signal of the waveform type based at least in part on transmitting the control signal and encoding one or more bits of the wake-up signal, wherein a first bit value for encoding the one or more bits is based at least in part on the base frequency and a second bit value for encoding the one or more bits is based at least in part on a frequency shift relative to the base frequency in accordance with the pair of frequency shift values for the wake-up signal; and transmitting the wake-up signal of the waveform type based at least in part on the generating.

Aspect 26: The method of aspect 25, wherein the second bit value is based at least in part on a first frequency shift relative to the base frequency in accordance with a first frequency shift value of the pair of the pair of frequency values, and a second frequency shift relative to the base frequency in accordance with a second frequency shift value of the pair of frequency shift values, the second frequency shift value opposite to the first frequency shift value.

Aspect 27: The method of any of aspects 25 through 26, wherein the first bit value for obtaining the one or more bits is mapped to a first subcarrier of a first resource block based at least in part on a first subcarrier index and the second bit value for obtaining the one or more bits is mapped to a second subcarrier of the first resource block based at least in part on a second subcarrier index and to a third subcarrier of the first resource block in accordance with a third subcarrier index.

Aspect 28: The method of any of aspects 25 through 26, wherein the first bit value for obtaining the one or more bits is mapped to a first subcarrier of a first resource block based at least in part on a first subcarrier index and the second bit value for obtaining the one or more bits is mapped to a second subcarrier of the first resource block based at least in part on a second subcarrier index and to a third subcarrier of a second resource block based at least in part on a third subcarrier index.

Aspect 29: The method of any of aspects 25 through 28, wherein transmitting the wake-up signal comprises: transmitting the wake-up signal during a wake-up signal reception occasion of a set of wake-up signal resources.

Aspect 30: The method of aspect 29, further comprising: transmitting a plurality of wake-up signals during a plurality of wake-up signal reception occasions based at least in part on transmitting the control signal and generating the plurality of wake-up signals, the plurality of wake-up signals comprising the wake-up signal, wherein the one or more parameters indicate a periodicity for monitoring for the plurality of wake-up signals during the plurality of wake-up signal reception occasions.

Aspect 31: The method of any of aspects 25 through 30, wherein the wake-up signal is associated with a transition of a main radio of the UE from a sleep state to an active state based at least in part on a successful decoding of the wake-up signal and a transition time for activation of the main radio.

Aspect 32: The method of aspect 31, wherein the sleep state is associated with a deactivation of one or more components associated with the main radio of the UE, of a wake-up radio of the UE, or both, the transition of the main radio to the active state is associated with an activation of at least one component of the one or more components based at least in part on the transition time.

Aspect 33: The method of any of aspects 25 through 32, wherein the waveform type comprises a frequency modulated waveform type, wherein an amplitude of the frequency modulated waveform type is based at least in part on the pair of frequency shift values.

Aspect 34: The method of any of aspects 25 through 33, wherein a size of the frequency shift is greater than a size of a bandwidth associated with the wake-up signal, wherein the second bit value for obtaining the one or more bits is based at least in part on the size of the frequency shift.

Aspect 35: The method of any of aspects 25 through 34, wherein the frequency shift is based at least in part on an integer multiple of one or more of the pair of frequency shift values.

Aspect 36: The method of any of aspects 25 through 34, wherein the frequency shift is based at least in part on a power of two multiple of one or more of the pair of frequency shift values.

Aspect 37: The method of any of aspects 25 through 36, wherein the one or more parameters further indicate a quantity of frequency shifts relative to the base frequency in accordance with the pair of frequency shift values, a total bandwidth for the wake-up signal comprising the base frequency and the pair of frequency shift values, or both.

Aspect 38: A method for wireless communications at a network entity, comprising: receiving a control signal indicating a transition time for activation of a main radio of a UE, wherein the transition time is based at least in part on a capability of the UE; transmitting a second control signal indicating one or more gap values associated with one or more wake-up signal reception occasions for monitoring for one or more wake-up signals, the one or more wake-up signal reception occasions associated with paging signal reception occasion for monitoring for a paging signal, wherein a first wake-up signal reception occasion of the one or more wake-up signal reception occasions is associated with an active state and the indicated transition time; and transmitting, during a sleep state of the UE, a wake-up signal during the first wake-up signal reception occasion based at least in part on a first gap value of the one or more gap values, the first gap value associated with the first wake-up signal reception occasion.

Aspect 39: The method of aspect 38, wherein transmitting the second control signal indicating the one or more gap values associated with the one or more wake-up signal reception occasions comprises: transmitting the second control signal indicating the first gap value associated with the first wake-up signal reception occasion and a second gap value of the one or more gap values, the second gap value associated with a second wake-up signal reception occasion of the one or more wake-up signal reception occasions, wherein transmitting the wake-up signal during the first wake-up signal reception occasion is based at least in part on the first gap value associated with the first wake-up signal reception occasion being greater than the indicated transition time.

Aspect 40: The method of aspect 39, wherein the first gap value is less than or equal to the second gap value, wherein transmitting the wake-up signal during the first wake-up signal reception occasion is based at least in part on the first gap value being less than or equal to the second gap value.

Aspect 41: The method of aspect 39, wherein the first gap value is greater than the second gap value, wherein transmitting the wake-up signal during the first wake-up signal reception occasion is based at least in part on the first gap value being greater than the second gap value and the second gap value being less than or equal to the indicated transition time.

Aspect 42: The method of any of aspects 38 through 41, further comprising: transmitting a timing offset indicator indicating a first value or a second value, wherein transmitting the wake-up signal during the first wake-up signal reception occasion is based at least in part on transmitting the timing offset indicator.

Aspect 43: The method of aspect 42, wherein the first value of the timing offset indicator is associated with the active state, and the second value of the timing offset indicator is associated with a time offset, the active state, and a difference between the transition time and the first gap value satisfying a threshold.

Aspect 44: The method of any of aspects 42 through 43, wherein the timing offset indicator is transmitted within the wake-up signal.

Aspect 45: The method of any of aspects 38 through 44, wherein the sleep state is associated with a deactivation of one or more components associated with a main radio of the UE, of a wake-up radio of the UE, or both, and a transition of the main radio to the active state comprises an activation of at least one component of the one or more components based at least in part on the transition time.

Aspect 46: The method of aspect 45, wherein the transition time comprises a time duration for the transition of the main radio to the active state and for the at least one component to turn on, and is based at least in part on a capability of the UE.

Aspect 47: The method of any of aspects 38 through 46, wherein the first gap value comprises a time duration between the first wake-up signal reception occasion and the paging signal reception occasion.

Aspect 48: An apparatus for wireless communications at a UE, comprising at least one processor; and memory coupled with the at least one processor, the memory storing instructions executable by the at least one processor to cause the UE to perform a method of any of aspects 1 through 13.

Aspect 49: An apparatus for wireless communications at a UE, comprising at least one means for performing a method of any of aspects 1 through 13.

Aspect 50: A non-transitory computer-readable medium storing code for wireless communications at a UE, the code comprising instructions executable by at least one processor to perform a method of any of aspects 1 through 13.

Aspect 51: An apparatus for wireless communications at a UE, comprising at least one processor; and memory coupled with the at least one processor, the memory storing instructions executable by the at least one processor to cause the UE to perform a method of any of aspects 14 through 24.

Aspect 52: An apparatus for wireless communications at a UE, comprising at least one means for performing a method of any of aspects 14 through 24.

Aspect 53: A non-transitory computer-readable medium storing code for wireless communications at a UE, the code comprising instructions executable by at least one processor to perform a method of any of aspects 14 through 24.

Aspect 54: An apparatus for wireless communications at a network entity, comprising at least one processor; and memory coupled with the at least one processor, the memory storing instructions executable by the at least one processor to cause the network entity to perform a method of any of aspects 25 through 37.

Aspect 55: An apparatus for wireless communications at a network entity, comprising at least one means for performing a method of any of aspects 25 through 37.

Aspect 56: A non-transitory computer-readable medium storing code for wireless communications at a network entity, the code comprising instructions executable by at least one processor to perform a method of any of aspects 25 through 37.

Aspect 57: An apparatus for wireless communications at a network entity, comprising at least one processor; and memory coupled with the at least one processor, the memory storing instructions executable by the at least one processor to cause the network entity to perform a method of any of aspects 38 through 47.

Aspect 58: An apparatus for wireless communications at a network entity, comprising at least one means for performing a method of any of aspects 38 through 47.

Aspect 59: A non-transitory computer-readable medium storing code for wireless communications at a network entity, the code comprising instructions executable by at least one processor to perform a method of any of aspects 38 through 47.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
at least one processor; and
memory coupled with the at least one processor, the memory storing instructions executable by the at least one processor to cause the UE to:
receive a control signal indicating a waveform type for a wake-up signal for the UE and indicating one or more parameters for the waveform type, wherein the one or more parameters indicate a base frequency for the wake-up signal and a pair of frequency shift values associated with the wake-up signal;
monitor, using a wake-up radio of the UE, for the wake-up signal of the waveform type based at least in part on the one or more parameters; and
decode the wake-up signal to obtain one or more bits of the wake-up signal based at least in part on the monitoring, wherein a first bit value for obtaining the one or more bits is based at least in part on the base frequency and a second bit value for obtaining the one or more bits is based at least in part on a frequency shift relative to the base frequency in accordance with the pair of frequency shift values for the wake-up signal.

2. The apparatus of claim 1, wherein the instructions to decode the wake-up signal are executable by the at least one processor to cause the UE to:
obtain one or more bits associated with the second bit value based at least in part on a first frequency shift relative to the base frequency in accordance with a first frequency shift value of the pair of frequency values, and a second frequency shift relative to the base frequency in accordance with a second frequency shift value of the pair of frequency shift values, the second frequency shift value opposite to the first frequency shift value.

3. The apparatus of claim 1, wherein the instructions to decode the wake-up signal are executable by the at least one processor to cause the UE to:
obtain one or more bits of the first bit value based at least in part on the first bit value being mapped to a first subcarrier of a first resource block in accordance with a first subcarrier index; and
obtain one or more bits of the second bit value based at least in part on the second bit value being mapped to a second subcarrier of the first resource block in accordance with a second subcarrier index and to a third subcarrier of the first resource block in accordance with a third subcarrier index.

4. The apparatus of claim 1, wherein the instructions to decode the wake-up signal are executable by the at least one processor to cause the UE to:
obtain one or more bits of the first bit value based at least in part on the first bit value being mapped to a first subcarrier of a first resource block in accordance with a first subcarrier index; and
obtain one or more bits of the second bit value based at least in part on the second bit value being mapped to a second subcarrier of the first resource block in accordance with a second subcarrier index and to a third subcarrier of a second resource block in accordance with a third subcarrier index.

5. The apparatus of claim 1, wherein the instructions to monitor for the wake-up signal are executable by the at least one processor to cause the UE to:
monitor for the wake-up signal during a wake-up signal reception occasion of a set of wake-up signal resources, wherein decoding the wake-up signal is based at least in part on monitoring for the wake-up signal during the wake-up signal reception occasion.

6. The apparatus of claim 5, wherein the instructions are further executable by the at least one processor to cause the UE to:
monitor for a plurality of wake-up signals during a plurality of wake-up signal reception occasions based at least in part on the one or more parameters, the plurality of wake-up signals comprising the wake-up signal, wherein the one or more parameters indicate a periodicity for monitoring for the plurality of wake-up signals during the plurality of wake-up signal reception occasions.

7. The apparatus of claim 1, wherein the instructions are further executable by the at least one processor to cause the UE to:
transition a main radio of the UE from a sleep state to an active state based at least in part on a successful decoding of the wake-up signal and in accordance with a transition time for activation of the main radio.

8. The apparatus of claim 7, wherein the sleep state is associated with a deactivation of one or more components associated with the main radio of the UE, of the wake-up radio, or both, wherein the instructions to transition to the active state are executable by the at least one processor to cause the UE to:
activate at least one component of the one or more components based at least in part on the transition time.

9. The apparatus of claim 1, wherein the waveform type comprises a frequency modulated waveform type, wherein an amplitude of the frequency modulated waveform type is based at least in part on the pair of frequency shift values.

10. The apparatus of claim 1, wherein a size of the frequency shift is greater than a size of a bandwidth associated with the wake-up signal, wherein the second bit value for obtaining the one or more bits is based at least in part on the size of the frequency shift.

11. The apparatus of claim 1, wherein the frequency shift is based at least in part on an integer multiple of one or more of the pair of frequency shift values.

12. The apparatus of claim 1, wherein the frequency shift is based at least in part on a power of two multiple of one or more of the pair of frequency shift values.

13. The apparatus of claim 1, wherein the one or more parameters indicate a quantity of frequency shifts relative to the base frequency in accordance with the pair of frequency shift values, a total bandwidth for the wake-up signal comprising the base frequency and the pair of frequency shift values, or both.

14. An apparatus for wireless communications at a user equipment (UE), comprising:
at least one processor; and
memory coupled with the at least one processor, the memory storing instructions executable by the at least one processor to cause the UE to:
transmit, to a network entity, a control signal indicating a transition time for activation of a main radio of the UE, wherein the transition time is based at least in part on a capability of the UE;
receive a second control signal indicating one or more gap values associated with one or more wake-up signal reception occasions for monitoring for one or more wake-up signals, the one or more wake-up signal reception occasions associated with a paging signal reception occasion for monitoring for a paging signal;
monitor, during a sleep state using a wake-up radio of the UE, for a wake-up signal of the one or more wake-up signals during a first wake-up signal reception occasion of the one or more wake-up signal reception occasions based at least in part on a first gap value of the one or more gap values; and
transition a main radio of the UE to an active state before the paging signal reception occasion based at least in part on reception of the wake-up signal during the first wake-up signal reception occasion and the indicated transition time.

15. The apparatus of claim 14, wherein the instructions to receive the second control signal indicating the one or more gap values associated with the one or more wake-up signal reception occasions are executable by the at least one processor to cause the UE to:
receive the control signal indicating the first gap value associated with the first wake-up signal reception occasion and a second gap value of the one or more gap values, the second gap value associated with a second wake-up signal reception occasion of the one or more wake-up signal reception occasions, wherein monitoring for the wake-up signal during the first wake-up signal reception occasion is based at least in part on the first gap value associated with the first wake-up signal reception occasion being greater than the indicated transition time.

16. The apparatus of claim 15, wherein the first gap value is less than or equal to the second gap value, wherein monitoring for the wake-up signal during the first wake-up signal reception occasion is based at least in part on the first gap value being less than or equal to the second gap value.

17. The apparatus of claim 15, wherein the first gap value is greater than the second gap value, wherein monitoring for the wake-up signal during the first wake-up signal reception occasion is based at least in part on the first gap value being greater than the second gap value and the second gap value being less than or equal to the indicated transition time.

18. The apparatus of claim 14, wherein the instructions are further executable by the at least one processor to cause the UE to:
receive a timing offset indicator, wherein transitioning the main radio to the active state is based at least in part on receiving the timing offset indicator.

19. The apparatus of claim 18, wherein the instructions to transition the main radio to the active state are executable by the at least one processor to cause the UE to:
transition the main radio to the active state following the first wake-up signal reception occasion based at least in part on a first value of the timing offset indicator.

20.-24. (canceled)

25. An apparatus for wireless communications at a network entity, comprising:
at least one processor; and
memory coupled with the at least one processor, the memory storing instructions executable by the at least one processor to cause the network entity to:
transmit a control signal indicating a waveform type for a wake-up signal for a user equipment (UE) and indicating one or more parameters for the wake-up signal, wherein the one or more parameters indicate a base frequency for the wake-up signal and a pair of frequency shift values associated with the wake-up signal;
generate the wake-up signal of the waveform type based at least in part on transmitting the control signal and encoding one or more bits of the wake-up signal, wherein a first bit value for encoding the one or more bits is based at least in part on the base frequency and a second bit value for encoding the one or more bits is based at least in part on a frequency shift relative to the base frequency in accordance with the pair of frequency shift values for the wake-up signal; and
transmit the wake-up signal of the waveform type based at least in part on the generating.

26.-30. (canceled)
